(19) United States
(12) Patent Application Publication
(10) Pub. No.: US 2023/0011049 A1
(43) Pub. Date: Jan. 12, 2023

(54) MANUFACTURING APPARATUS FOR MANUFACTURING A COMPOSITION FROM A MIXTURE OF FORMULATIONS

(71) Applicants: SEB S.A., Ecully (FR); Duolab International Sarl, Plan-les-Ouates (CH)

(72) Inventors: Pierre Alain DURIF, Monsteroux Milieu (FR); Edgar VALLA DURY, La Talaudière (FR); Jacky CHELLE, Auberives sur Vareze (FR)

(21) Appl. No.: 17/784,863

(22) PCT Filed: Dec. 14, 2020
(86) PCT No.: PCT/FR2020/052422

§ 371 Date: Jun. 13, 2022

(30) Foreign Application Priority Data
Dec. 12, 2019 (FR) FR1914251

(51) Int. Cl. B01F 33/501; B01F 31/55; A45D 40/24; A45D 34/00; B01F 23/70; B01F 31/00; B01F 35/21; B01F 35/214; B01F 35/32; B01F 35/60; B01F 35/71; B01F 35/75; B01F 35/92

(52) U.S. Cl. CPC B01F 33/5011; B01F 31/55; A45D 40/24; A45D 34/00; B01F 23/711; B01F 31/70; B01F 35/2115; B01F 35/214; B01F 35/32025; B01F 35/6052; B01F 35/7131; B01F 35/7164; B01F 35/7546; B01F 35/92; A45D 2200/058; B01F 2101/21

(57) ABSTRACT

The manufacturing apparatus includes a first capsule containing a first formulation; a second capsule containing a second formulation; a receiving device configured to receive the first and second capsules; a mixing machine including a receiving housing configured to receive the receiving device equipped with the first and second capsules, and a control unit configured to control the operation of the mixing machine; and a detection device configured to detect the presence of the receiving device in the receiving housing.

### CROSS REFERENCE TO RELATED APPLICATIONS

This application is a National Stage of PCT Application No. PCT/FR2020/052422 filed on Dec. 14, 2020, which claims priority to French Patent Application No. 19/14251 filed on Dec. 12, 2019, the contents each of which are incorporated herein by reference thereto.

### TECHNICAL FIELD

The present invention concerns a manufacturing apparatus for manufacturing a composition, in particular cosmetic, or more precisely for preparing a composition by mixing two formulations.

### BACKGROUND

FR3067910 discloses a manufacturing apparatus for manufacturing a composition, and more particularly a cosmetic product, the manufacturing apparatus including:
a first capsule including a first compartment containing a predetermined quantity of a first formulation, and a first connection portion,
a second capsule including a second compartment containing a predetermined quantity of a second formulation, and a second connection part configured to be connected to the first connection portion,
a receiving device comprising:

a first receiving location, configured to receive the first capsule,

a second receiving location, configured to receive the second capsule, and
a mixing machine including:

a receiving housing configured to at least partially receive the receiving device equipped with the first and second capsules, and

an actuation system configured to mix the first and second formulations directly inside the first and second capsules so as to obtain the cosmetic product.

The actuation system includes in particular:
a first actuation member positioned on one side of the receiving housing, and movable inside the receiving housing, in order to transmit a pressure force to the first capsule when the receiving device equipped with the first and second capsules is received in the receiving housing of the mixing machine,
a second actuation member, positioned on another side, preferably opposite, of the receiving housing, and movable inside the receiving housing, in order to transmit a pressure force to the second capsule when the receiving device equipped of the first and second capsules is received in the receiving housing of the mixing machine, and
a driving motor mechanically connected to the first and second actuation members and configured to allow cyclic displacement of the first and second actuation members between inactive and active positions. Such a manufacturing apparatus allows the manufacturing, by an end consumer, of a personalized cosmetic product from different capsules.

However, in the case of abnormal use of the manufacturing apparatus described in FR3067910, for example during activation of the actuation system while the receiving device is not received or is not fully inserted into the receiving housing, the actuation system is likely to pinch a user fingers if the latter inserts his fingers inside the receiving housing. Similarly, when the mixing machine is provided with a heating element disposed in the receiving housing and configured to heat one or each of the first and second capsules, the heating element is likely to burn the user if the receiving device is not received or is not fully inserted into the receiving housing.

### BRIEF SUMMARY

The present invention aims to remedy all or part of these drawbacks.

The technical problem underlying the invention therefore consists in providing an apparatus for manufacturing a composition which is simple, compact and easy to use, while presenting increased safety of use.

In this regard, the invention provides a manufacturing apparatus for the manufacture of a composition, comprising:
a first capsule containing a first formulation and comprising a first connection part, and a second capsule containing a second formulation and comprising a second connection part configured to be connected to the first connection part,
a receiving device configured to receive the first capsule and the second capsule,
a mixing machine including:

a receiving housing configured to at least partially receive the receiving device equipped with the first and second capsules,

a control unit configured to control the operation of the manufacturing apparatus,

characterized in that the manufacturing apparatus further includes a detection device configured to detect the presence of the receiving device in the receiving housing, and in that the control unit is configured to control the operation of the manufacturing apparatus at least partly as a function of the detection, by the detection device, of the presence of the receiving device in the receiving housing.

Such a configuration of the manufacturing apparatus makes it possible in particular to avoid the activation of a mechanical system arranged in the mixing machine and including a movable element configured to penetrate into the receiving housing, in the absence of the receiving device in the receiving housing. These provisions thus make it possible to avoid any risk of pinching of a user fingers and therefore to give the manufacturing apparatus according to the invention great safety in use.

The manufacturing apparatus may further have one or more of the following characteristics, taken alone or in combination.

In an embodiment, the receiving device comprises a first receiving location configured to receive the first capsule, and a second receiving location configured to receive the second capsule.

In an embodiment, the mixing machine includes an actuation system comprising:
a first actuation member positioned on one side of the receiving housing, and movable inside the receiving housing, in order to transmit a pressure force to the first capsule when the receiving device equipped with the first and second capsules is received in the receiving housing of the mixing machine, and
a second actuation member, positioned on another side, preferably opposite, of the receiving housing, and movable inside the receiving housing, in order to transmit a pressure force to the second capsule when the receiving device equipped with the first and second capsules is received in the receiving housing of the mixing machine.

The actuation system is more particularly configured to mix the first and second formulations contained in the first and second capsules so as to obtain the composition.

In an embodiment, the receiving device comprises a first actuation face, allowing a transfer of a pressure force on the first capsule, and a second actuation face, opposite the first actuation face, allowing a transfer of a pressure force onto the second capsule, and the first and second actuation members are configured to transmit pressure forces respectively on the first and second actuation faces of the receiving device when the receiving device equipped with the first and second capsules is received in the receiving housing of the mixing machine.

In an embodiment, the control unit is configured to activate the actuation system, and more particularly to control movements of the first actuation member and/or of the second actuation member, only if the detection device has detected the presence of the receiving device in the receiving housing.

In an embodiment, the receiving device includes a first electrical circuit portion and the mixing machine includes a second electrical circuit portion configured to cooperate electrically with the first electrical circuit portion when the receiving device equipped with the first and second capsules is received in the receiving housing of the mixing machine, the detection device being configured to detect the electrical cooperation between the first and second electrical circuit portions so as to detect the presence of the receiving device in the receiving housing of the mixing machine.

In an embodiment, the detection device is configured to detect electrical continuity between the first and second electrical circuit portions when the receiving device equipped with the first and second capsules is received in the receiving housing of the mixing machine. Such a configuration of the detection device avoids having to resort to an additional sensor which would be expensive and complex. In an embodiment, the first electrical circuit portion comprises a first and a second electrical contact track provided on the receiving device and the second electrical circuit portion comprises a first and a second electrical contact track provided on the mixing machine and configured to be respectively engaged with the first and second electrical contact tracks provided on the receiving device when the receiving device equipped with the first and second capsules is received in the receiving housing of the mixing machine, the detection device being configured to detect electrical continuity between the first and second electrical contact tracks provided on the receiving device and the first and second electrical contact tracks provided on the mixing machine.

In an embodiment, the receiving device includes a heating circuit configured to heat at least one of the first and second capsules when the receiving device equipped with the first and second capsules is received in the receiving housing of the mixing machine, the heating circuit including the first electrical circuit portion.

In an embodiment, the heating circuit includes a heating element configured to heat at least one of the first and second capsules when the receiving device equipped with the first and second capsules is received in the receiving housing of the mixing machine.

In an embodiment, the heating circuit includes a temperature sensor configured to measure the temperature prevailing near the heating element.

In an embodiment, the heating circuit includes a temperature regulation circuit which comprises the temperature sensor and the first electrical circuit portion.

In an embodiment, the first and second electrical contact tracks provided on the receiving device are electrically connected to the temperature sensor and are configured to electrically power the temperature sensor when the receiving device equipped with the first and second capsules is received in the receiving housing of the mixing machine.

In an embodiment, the heating circuit includes a heating power transfer circuit including the heating element and a pair of electrical contact tracks which are provided on the receiving device and which are electrically connected to the heating element, and the mixing machine has a pair of electrical contact tracks which are configured to be respectively engaged with the pair of electrical contact tracks of the heating power transfer circuit when the receiving device equipped with the first and second capsules is received in the receiving housing of the mixing machine.

In an embodiment, the mixing machine includes a detection element configured to detect the presence of the first and second capsules in the receiving device when the receiving device is received in the receiving housing. In an embodiment, the detection element is formed by the control unit.

In an embodiment, the mixing machine includes a coupling mechanism configured to establish a sealed connection between the first and second connection parts of the first and second capsules when the receiving device equipped with the first and second capsules is received in the receiving housing.

In an embodiment, the coupling mechanism includes a coupling element that is movable between an insertion position and a coupling position, and an auxiliary motor that is configured to displace the coupling element between the insertion position and the coupling position, the coupling element being configured to:

in the insertion position, not interfere with the insertion and the removal of the receiving device into the receiving housing and,

in the coupling position, exert an effort on one actuation face of the receiving device so as to establish a sealed connection between the first and second connection parts of the first and second capsules when the receiving device equipped with the first and second capsules is received in the receiving housing.

In an embodiment, the control unit is configured to measure the current consumed by the auxiliary motor during an operating cycle of the auxiliary motor, and to detect the presence of the first and second capsules in the receiving device and the establishment of a sealed connection between the first and second connection parts of the first and second capsules when a consumed current peak, representative of a sealed connection between the first and second capsules, is detected by the control unit during an operating cycle of the auxiliary motor, and for example during a connection phase of the operating cycle of the auxiliary motor. These arrangements make it possible to easily detect, and without additional device, the presence of the first and second capsules in the receiving device when the receiving device is received in the receiving housing. These arrangements also make it possible to ensure a sealed connection between the first and second capsules before activating in particular the actuation system, and therefore to avoid any leakage of fluid inside the receiving device and the mixing machine.

In an embodiment, the control unit is configured to detect an initial consumed current peak during an initial phase of an operating cycle of the auxiliary motor and to detect a final consumed current peak during a final phase of an operating cycle of the auxiliary motor, the control unit being configured to detect the establishment of a sealed connection between the first and second connection parts of the first and second capsules when a consumed current peak, representative of a sealed connection between the first and second capsules, is detected by the control unit between the detection of the initial current consumption peak and the detection of the final current consumption peak.

The initial current consumption peak is more particularly due to the torque required to initiate a movement of the auxiliary motor, and the final current consumption peak is more particularly due to a blockage in rotation of the auxiliary motor, for example related to the presence of an end stop cooperating with the coupling element.

In an embodiment, the consumed current peak, representative of a sealed connection between the first and second capsules, has a maximum value greater than a predetermined threshold value.

In an embodiment, the receiving device includes a coupling button configured to bear on one of the first and second capsules, the coupling element being configured to cooperate with the coupling button when the coupling element is displaced into the coupling position.

In an embodiment, the control unit is configured to activate the actuation system, and more particularly to control movements of the first actuation member and/or of the second actuation member, only if the detection device has detected the presence of the receiving device in the receiving housing and if the control unit has detected a consumed current peak representative of a sealed connection between the first and second capsules.

In an embodiment, the control unit is configured to emit a warning signal, for example audible or visual, when the presence of the first and second capsules in the receiving device is not detected by the detection element.

In an embodiment, the control unit is configured to emit a warning signal, for example audible or visual, when the presence of the receiving device in the receiving housing is not detected by the detection device.

In an embodiment, the control unit is configured to emit a warning signal, for example audible or visual, when no consumed current peak, representative of a sealed connection between the first and second capsules, is detected by the control unit.

In an embodiment, the control unit is configured to emit a warning signal, for example audible or visual, when electrical continuity between the first and second electrical circuit portions is not detected by the control unit.

In an embodiment, the receiving device is configured to occupy an open position in which the first and second capsules are capable of being introduced into the receiving device, and a closed position in which the receiving device is configured to maintain the first and second capsules in position.

In an embodiment, the receiving device is configured to pre-connect the first and second connection portions of the first and second capsules when the receiving device is displaced into the closed position.

In an embodiment, the first and second electrical contact tracks provided on the receiving device are positioned respectively on the first and second connection faces of the receiving device.

In an embodiment, the first and second connection faces of the receiving device are opposed to each other.

In an embodiment, the first and second actuation faces of the receiving device are opposed to each other.

In an embodiment, the first connection face extends between, preferably connects, the first and the second actuation face of the receiving device, and/or the second connection face extends between, preferably connects, the first and second actuation face of the receiving device.

In an embodiment, the first and second connection faces are separate from the first and second actuation faces.

In an embodiment, the receiving device comprises a first protective shell, inside which the first receiving location is located and a second protective shell inside which the second receiving location is located, the second protective shell being movably mounted relative to the first protective shell by a hinge, the receiving device further including a separation wall carrying the heating element.

In an embodiment, the pair of electrical contact tracks belonging to the heating power transfer circuit are mounted on the separation wall.

In an embodiment, the first and second electrical contact tracks are respectively positioned in the first and second grooves provided on the receiving device.

In an embodiment, the pair of electrical contact tracks belonging to the power transfer circuit are positioned respectively in the first and second grooves provided on the receiving device.

In an embodiment, the first actuation face comprises a first bearing element configured to exert a pressure force on the first capsule, and the second actuation face comprises a second bearing element configured to exert a force pressure on the second capsule.

In an embodiment, the electrical contact tracks provided on the mixing machine are arranged on two rails provided in the receiving housing.

### BRIEF DESCRIPTION OF THE DRAWINGS

Other characteristics, objects and advantages of the invention will emerge from the description which follows, which is purely illustrative and not limiting, and which must be read in conjunction with the appended drawings.

FIG. 1A is a perspective view of a manufacturing apparatus, with the mixing machine and the receiving device not inserted, according to an embodiment of the invention.

FIG. 1B is a view similar to FIG. 1A, with the receiving device inserted, according to an embodiment of the invention.

FIG. 2A is a 3D view of a receiving device according to an embodiment in accordance with that of FIG. 1A, with capsules substantially in position before insertion.

FIG. 2B is a cross-sectional view of a receiving device and capsules, similar to those of FIG. 2A.

FIG. 3A is an exploded 3D view of a receiving device according to an embodiment in accordance with that of FIG. 1A, with capsules positioned opposite their respective receiving location.

FIG. 3B is similar to FIG. 3A, with a rotation of approximately 90° of each part on itself.

FIG. 4A is a side view (of the connection face) of a receiving device according to an embodiment in accordance with that of FIG. 1A, with the capsules inserted.

FIG. 4B is similar to FIG. 4A, with a rotation about the longitudinal axis X of 180°.

FIG. 5 is a 3D view, partially exploded, of a receiving device according to an embodiment in accordance with that of FIG. 1A.

FIG. 6 is a partial 3D view of the mixing machine according to an embodiment in accordance with that of FIG. 1A, showing in particular the actuation system and the actuation motor.

FIG. 7A is a top view of the mixing machine according to an embodiment in accordance with that of FIG. 1A.

FIG. 7B is a view from below of the mixing machine according to an embodiment in accordance with that of FIG. 1A, with the battery visible.

FIG. 8A is a partial top view of the manufacturing apparatus with the mixing machine and the receiving device, in a neutral position for insertion and removal of the receiving device, with a schematic illustration of the actuation strokes.

FIG. 8B is a partial top view of the manufacturing apparatus with the mixing machine and the receiving device, with an actuation system at the middle of an actuation stroke.

FIG. 8C is a partial top view of the manufacturing apparatus with the mixing machine and the receiving device, with an actuation system at the end of the actuation stroke.

FIG. 9 is a top view of the mixing machine according to an embodiment in accordance with that of FIG. 1A, showing in particular the actuation system, the actuation motor, and the connection for driving the actuation system, and where the actuation system is in an extreme position of the actuation stroke.

FIG. 10A is a partial 3D view of the mixing machine, to illustrate the retention mechanism, the clamping mechanism and the coupling mechanism, in the insertion position.

FIG. 10B is a partial, more accurate, 3D view of the mixing machine, to illustrate the retention mechanism, the clamping mechanism and the coupling mechanism, in the insertion position.

FIG. 10C is a partial, more accurate, 3D view of the mixing machine, to illustrate the retention mechanism and the coupling mechanism, in the retention and coupling position.

FIG. 10D is a partial 3D view, of the fabrication apparatus, to illustrate the retention mechanism and the coupling mechanism, in the insertion position.

FIG. 10E is a partial 3D view, of the fabrication apparatus, to illustrate the retention mechanism and the coupling mechanism, in the retention and coupling position.

FIG. 10F is an exploded view of the clamping mechanism, retention mechanism, and coupling mechanism.

FIG. 11A is a partial 3D view of the mixing machine with the first capsule, to illustrate the clamping mechanism, in the insertion position.

FIG. 11B is similar to FIG. 11A, viewed from another angle, except that some parts have been removed for more visibility.

FIG. 11C is similar to FIG. 11A, except that more parts have still been removed, in the clamping position.

FIG. 12 is a partial 3D view of the mixing machine, showing an embodiment of the circuit board with a controller/processor and a memory.

FIG. 13 is a diagram representing the evolution of the current I consumed by an auxiliary motor as a function of time T.

### DETAILED DESCRIPTION

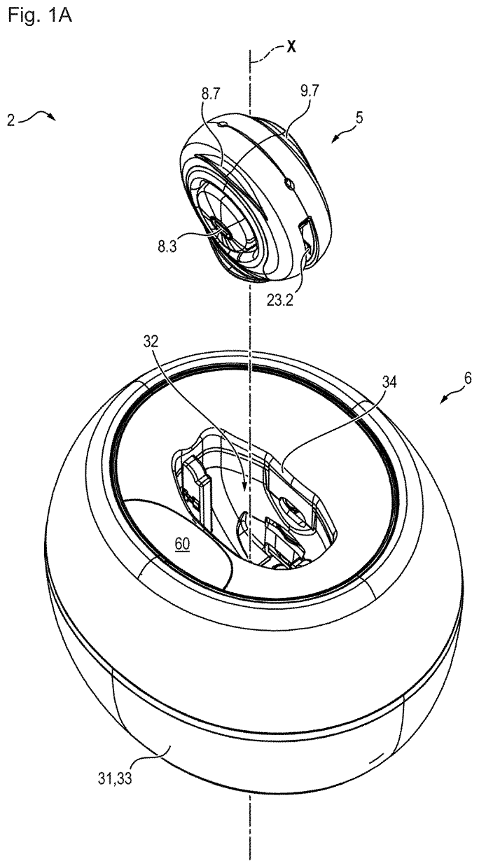

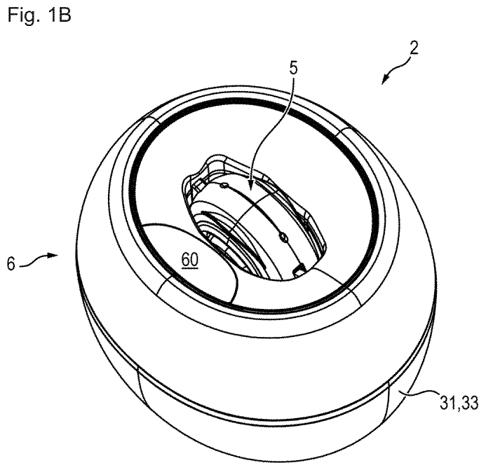

FIGS. 1A and 1B represent a manufacturing apparatus 2, according to a first embodiment of the invention, configured to manufacture a composition, which can for example be a cosmetic product, a hair care product, a pharmaceutical product, a phytosanitary product, a maintenance product, a cleaning product, or even an agri-food product. When the composition to be manufactured is a cosmetic product, the latter can for example be a homogenized emulsion, a homogenized solution or even a mixture of several miscible phases.

The manufacturing apparatus 2 is intended for essentially personal use and on a small scale: it allows the preparation of single portions ready for use. Consequently, its dimensions must meet space constraints in a bathroom, a beauty salon, luggage (for transport), etc. Thus, the manufacturing apparatus does not have a dimension greater than 40 cm.

The manufacturing apparatus 2 comprises receiving means configured to receive first and second capsules 3, 4, also called pods or packaging units, respectively containing a predetermined quantity of a first formulation and a predetermined quantity of a second formulation, and a mixing machine 6 configured to mix the first and second formulations contained in the first and second capsules 3, 4 received in the manufacturing apparatus 2, so as to obtain a cosmetic product.

In a preferred embodiment and particularly visible in all FIGS. 1A, 1B, 7A, 8A, 8B, 8C, the mixing machine 6 comprises a receiving housing 32 capable of receiving a receiving device 5 in a removable manner. The receiving housing 32 in this case has a shape substantially complementary to that of the receiving device 5.

The mixing machine 6 further comprises an actuation system 35 configured to exert a force on the capsules 3, 4, via the receiving device 5 if necessary, to allow the mixing and kneading of the composition to be manufactured.

The receiving device 5, also called a shuttle (because it serves as a vehicle for the capsules), preferably has a relatively symmetrical shape, either rectangular parallelepipedic, or oval/ovoid. A longitudinal direction X is defined for it, which corresponds to the direction in which it is inserted into the receiving housing 32. Consequently, the longitudinal direction X and the insertion direction coincide when the receiving device 5 is inserted into the mixing machine 6.

Advantageously, the mixing machine 6 is configured to mix the first and second formulations inside the receiving device 5, and preferably inside the first and second capsules 3, 4, without any of the formulations come into contact with the manufacturing apparatus.

Advantageously, the first formulation is a first phase of a cosmetic product to be manufactured, such as a fatty phase of the cosmetic product, while the second formulation is a second phase of the cosmetic product, such as an aqueous phase of the cosmetic product. For example, the fatty phase can constitute the base of the cosmetic product to be manufactured, and the aqueous phase can comprise active elements and thus constitute a complex of active ingredients of the cosmetic product to be manufactured.

The Capsules

The two capsules that can be used in the presented manufacturing apparatus 2 are described in detail in the document FR3067911.

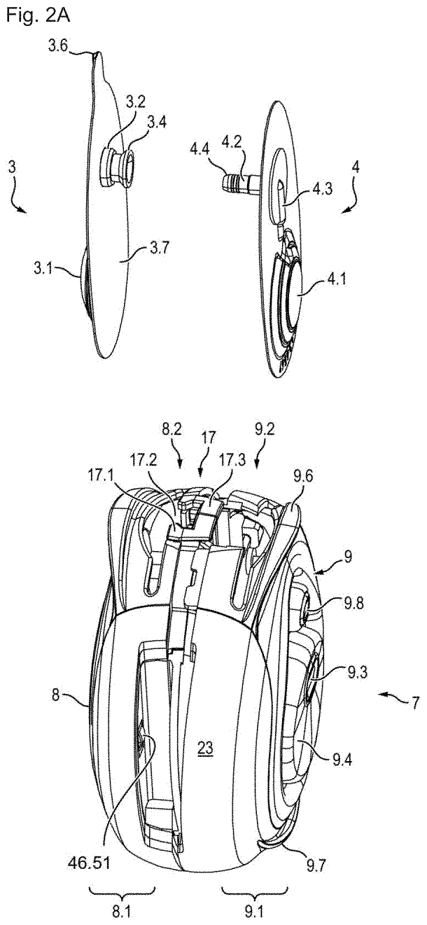

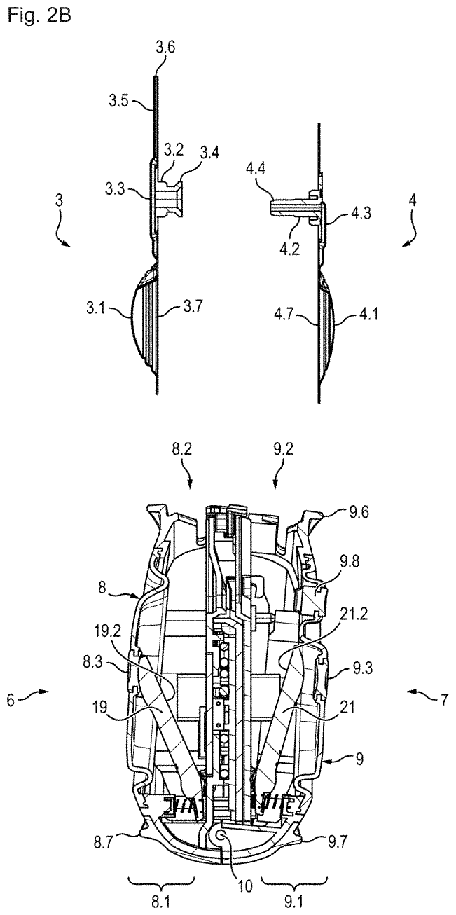

As shown more particularly in FIGS. 2A, 2B, 3A, 3B, 4A, 4B, the first and second capsules 3, 4 are separate from each other, and are configured to be fluidly connected to one another. Furthermore, each of the first and second capsules 3, 4 is advantageously for single use. The first capsule 3 includes a first deformable compartment 3.1, of domed shape, containing the first formulation, a first connection part 3.2 and a first connection passage 3.3 configured to fluidically connect the first deformable compartment 3.1 and the first connection part 3.2. Advantageously, the first connecting passage 3.3 is formed by a first connecting channel. The first connection part 3.2 more particularly comprises a female connection end piece 3.4, for example of cylindrical shape, fluidly connected to the first connecting passage 3.3. The first capsule 3 comprises a flat face 3.7 through which the connection part 3.2 passes.

The first capsule 3 further includes an outlet passage 3.5, such as an outlet channel, which is fluidly connected to the first connecting passage 3.3, and which is provided with an outlet orifice 3.6. Advantageously, the outlet passage 3.5 extends in the prolongation of the first connecting passage 3.3, and substantially parallel to the first connecting passage 3.3. In the present case, the outlet passage 3.5 can be either mounted on the first capsule 3 or on the second capsule 4. In fact, the outlet passage 3.5 is only requested in operation once the manufacturing apparatus 2 was used.

The second capsule 4 includes a second deformable compartment 4.1, of curved shape, containing the second formulation, a second connection part 4.2 configured to be connected to the first connection part 3.2, and a second connection passage 4.3 configured to fluidically connect the second deformable compartment 4.1 and the second connection part 4.2. Advantageously, the second connecting passage 4.3 is formed by a second connecting channel, and the second connecting part 4.2 extends substantially perpendicular to the second connecting passage 4.3. The second connection part 4.2 more particularly comprises a male connection end piece 4.4, for example of cylindrical shape, fluidly connected to the second connecting passage 4.3 and configured to receive the female connection end piece 3.4 in a sealed manner. The second capsule 4 comprises a flat face 4.7 through which the second connection part 4.2 passes.

The first and second capsules 3, 4 and more particularly the first and second deformable compartments 3.1, 4.1 are each closed by connection welds ensuring the seal of the capsules, these connection welds being breakable as soon as a threshold pressure is reached. These threshold pressures can be reached in the mixing machine 6. Again, these connection welds are described in detail in the description of the document filed under the application number FR 1755744

Each of the first and second capsules 3, 4 is configured to contain all or substantially all of a mixture formed by the predetermined quantity of the first formulation and the predetermined quantity of the second formulation. In this regard, either the deformable compartments are flexible, or buffer zones are provided. Again, the description of the document filed under the application number FR 1755744 describes this precisely.

The Receiving Device

As shown more particularly in FIGS. 2A, 2B, 3A, 3B, 4A, 4B and 5 the receiving device 5 is able to occupy an open position in which the first and second capsules 3, 4 are able to be introduced into the receiving device 5, and a closed position in which the receiving device 5 is able to hold the first and second capsules 3, 4 in position.

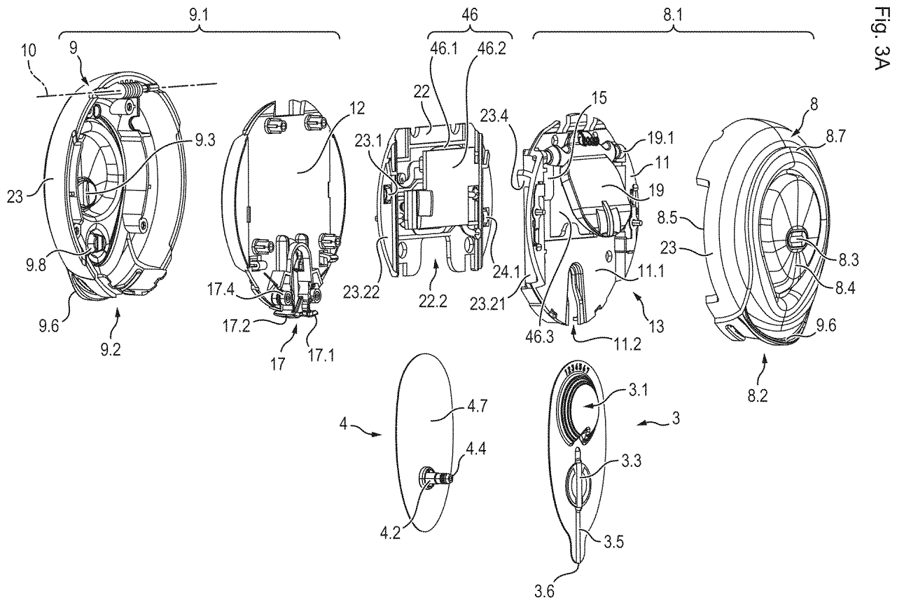

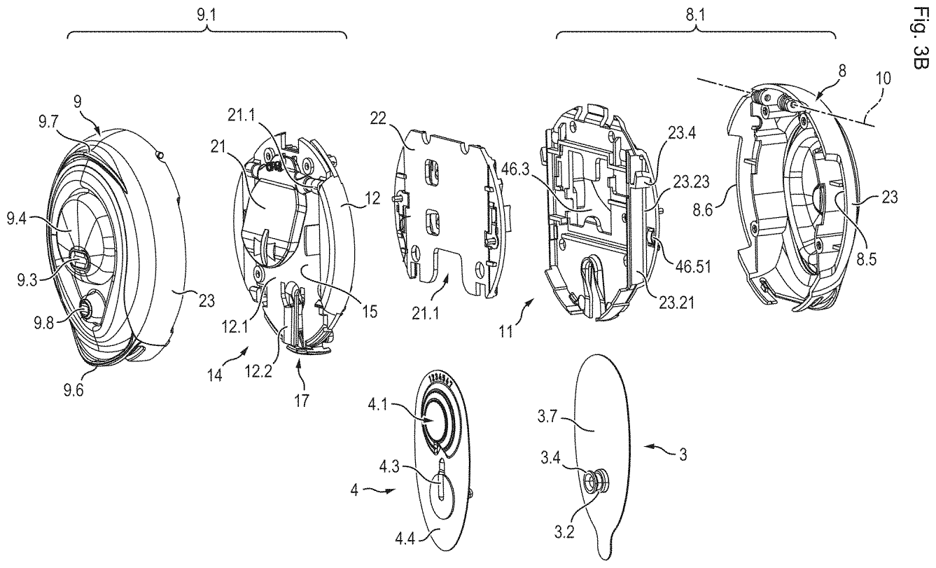

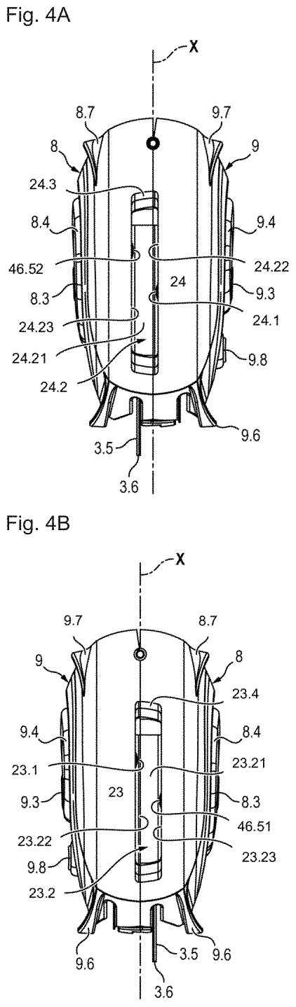

The receiving device 5 more particularly takes the form of a receiving casing 7 (FIGS. 2A, 2B) configured to receive and at least partially house the first and second capsules 3, 4. The receiving device 5 includes in particular a first protective shell 8 and a second protective shell 9 mounted articulated relative to each other about an articulation axis 10 (or hinge) and between a first position (see FIGS. 2A, 2B, 5) corresponding to an open position of the receiving device 5 and a second position (see FIGS. 4A, 4B) corresponding to a closed position of the receiving device 5. The receiving device 5 further comprises a first support part 11 and a second support part 12 arranged in the receiving casing 7. The first and second support parts 11, 12 respectively include a first receiving location 13 configured to receive the first capsule 3 and a second receiving location 14 configured to receive the second capsule 4.

The first and second protective shells 8, 9 each include an opening 8.2, 9.2 to allow access to the receiving locations 13, 14. These openings 8.2, 9.2 define an insertion face of the receiving device 5. The receiving device 5 comprises a removal face, opposite the insertion face.

Advantageously, the first support part 11 includes receiving wedges 15 configured to receive a peripheral portion of the first capsule 3, and the second support part 12 also includes receiving wedges 15 configured to receive a peripheral portion of the second capsule 4. These receiving wedges 15 partly define the first and second receiving locations 13, 14.

The first support part 11 comprises a first placement surface 11.1, configured to guide (with contact) and receive the flat face 3.7 of the first capsule 3. The first placement surface 11.1 therefore partly defines the first receiving location 13.

Similarly, the second support part 12 comprises a second placement surface 12.1, configured to guide (with contact) and receive the flat face 4.7 of the second capsule. The second placement surface 12.1 therefore partly defines the second receiving location 14.

When the first and second capsules 3, 4 are inserted, their respective flat faces 3.7, 4.7 are facing each other, with the two placement surfaces 11.1, 12.1 between them.

In order to authorize the passage of the first and second connection parts 3.2, 4.2 of the first and second capsules 3, 4, the first and second placement surfaces 11.1, 12.1 each comprise a passage opening 11.2, 12.2, in the form of a slot, open outwards, along an insertion axis X (FIG. 1A).

The receiving device 5 further comprises a separation wall 22, defining a separation plane (FIGS. 3A, 3B). The separation wall 22 is located between the two receiving locations 13, 14. It is also secured to the first support part 11. The separation wall 22 comprises a passage opening 22.1 in order to allow the first and second connection parts 3.2, 4.2 to be positioned in the receiving device. The passage opening 22.1 is in the form of a slot through the thickness and open to the outside.

The openings 11.2, 22.1, 12.2 therefore form a space to receive the connection end pieces 3.4, 4.4 of the first and second capsules 3, 4.

A first actuation face 8.1 which comprises the first shell 8 and the first support part 11 and a second actuation face 9.1 which comprises the second shell 9 and the second support part 12 are also defined.

Each actuation face 8.1, 9.1 intervenes in the transmission of the forces received by the receiving device 5 to the first and second capsules 3, 4. This will be explained in detail later.

Articulation

According to the embodiment visible in FIGS. 2A, 2B, 3A, 3B, 5, the first and second shells 8, 9 are articulated relative to each other about the articulation axis 10 and between a receiving position (see FIGS. 2A, 2B, 3A, 3B) in which the first and second shells 8, 9 are remote from each other and the first and second capsules 3, 4 are able to be received respectively in the first and second receiving locations 13, 14, and a connection position (see FIGS. 4A, 4B) in which the first and second shells 8, 9 are close together and the first and second capsules 3, 4 are pre-connected to each other. By pre-connected to each other it is meant that the tip of the male connection 4.4 of the second capsule 4 is partially introduced into the female connection end piece 3.4 of the first capsule 3 without, however, a sealed connection being established between these two capsules.

The first and second shells 8, 9 may for example have an angle of inclination greater than or equal to 7°, and for example about 7°, when they are in the receiving position, and be substantially parallel to each other when they are in the connection position. More precisely, there are two main assemblies that are only articulated relative to each other: the first shell 8, the first support part 11, the separation wall 22 and the second support part 12 on the one hand; and the second shell 9, on the other hand.

Advantageously, the first and second shells 8, 9 (or the actuation faces 8.1, 9.1) are configured to engage the first connection part 3.2 in the second connection part 4.2 when the receiving device 5 is displaced into the closed position. Indeed, when the two shells are in the closed position, the connection parts 3.2, 4.2 are partially nested with each other.

The first and second support parts 11, 12 are more particularly configured such that the first and second capsules 3, 4 extend substantially parallel to each other, when the first and second shells 8, 9 are in the connection position. As shown in FIGS. 4A, 4B, the first capsule 3 is configured to extend partly outside the receiving device 5 when it is received in the receiving device 5 and the latter is in the closed position.

Advantageously, the outlet orifice 3.6 is configured to extend outside the receiving device 5 when the first capsule 3 is received in the receiving device 5 and the latter is in the closed position.

The Heating Element

The receiving device 5 comprises a heating circuit configured to heat one of the first and second capsules 3, 4 when the receiving device 5 equipped with the first and second capsules 3, 4 is received in the receiving housing 32 of the mixing machine 6.

In the embodiment illustrated in the figures, the heating circuit includes a heating power transfer circuit comprising a heating element 46 visible in FIGS. 3A, 3B.

The heating element 46 is attached to the separation wall 22. During the design, it was chosen that the heating element 46 is on the side of the first support part 11, which means that the heating element 46 is mounted on the side of the separation wall 22 which is on the side of the first support part 11.

The heating element 46 preferably comprises one or more electric heating resistors 46.1 and a diffusion plate 46.2. The heating element 46 thus has a flat shape to better distribute the heat, if possible, with an area of at least 500 mm² and preferably in the range of 800 mm².

Nonetheless, as between the first capsule 3 and the heating element 46 is the first support part 11, there is provided in the first support part 11 a communication opening 46.3 which places the flat face 3.7 of the first capsule 3 with the heating element 46 (that is to say separated only by air).

The electrical contact tracks of the heating element

The heating element 46 needs to be supplied with electricity.

Preferably, the receiving device 5 does not include its own battery and must be supplied when it is inserted into the receiving housing 32. Therefore, an electrical connection is provided between the receiving device 5 and the mixing machine 6.

The receiving device 5 comprises the insertion face, where the openings 8.2, 9.2 are located and which is the face that first enters the receiving housing 32, and an opposite removal face, which is the visible face when the receiving device 5 is inserted into the receiving housing 32. The receiving device 5 further comprises a first actuation face 8.1 and a second actuation face 9.1, opposite each other.

Finally, the connection device 5 comprises a first connection face 23 and a second connection face 24, preferably opposite. In the embodiment illustrated in FIGS. 2A, 2B, 3A, 3B, 4A, 4B, the first and second connection faces 23 and 24 correspond to lateral faces of the receiving device 5 and are therefore distinct from the first and second actuation faces 8.1, 9.1 and insertion/removal faces.

The first and second connection faces 23, 24 extend between the actuation faces 8.1, 9.1 of the receiving device 5. Preferably, the connection faces 23, 24 interconnect the first and second actuation faces 8.1, 9.1 of the receiving device 5, that is to say that they are contiguous.

The general shape of the receiving device 5 is selected so that the first and second connection faces 23, 24 are further apart from each other than the first and second actuation faces 8.1, 9.1 (and the insertion/removal faces). In other words, if the smallest parallelepiped into which the receiving device 5 is inserted, is taken, the faces which touch the connection faces 23, 24 are further apart than the faces which touch the actuation faces 8.1, 9.1 and are closer than the faces that touch the insertion/removal faces. This results in the fact that the receiving device 5 is wider than it is thick (and moreover it is higher than it is wide).

The heating power transfer circuit further comprises a first electrical contact track 23.1 intended to supply the heating element 46 and provided on the first connection face 23, and a second electrical contact track 24.1 also intended to supply the heating element 46 and provided on the second connection face 24 (FIGS. 2A, 3A, 3B, 4A, 4B). The electrical tracks 23.1, 24.1 are therefore outside the receiving device 5, in order to be brought into contact with additional tracks provided on the mixing machine and detailed below (FIGS. 2A, 4A, 4B).

This configuration has several advantages: first, it ensures a simple and efficient electrical connection. It also avoids the risk of short circuit. Indeed, if ever liquid were to flow into the receiving housing 32 (for example water from the shower or the sink or quite simply a capsule which bursts), it is unlikely that the two tracks 23.1, 24.1 are touched at the same time by the same volume of liquid.

The first connection face 23 comprises a portion of the first and second shells 8, 9, of the first bearing element 11 and of the separation wall 22.

In particular, the first connection face 23 comprises a longitudinal groove 23.2 with a bottom 23.21 and two lateral walls 23.22, 23.23. The first electrical track 23.1 is preferably positioned on a lateral wall of the longitudinal groove 23.2. In the embodiment illustrated in FIGS. 3A, 3B, the bottom 23.21 and the lateral wall 23.23 are made by a portion of the first support part 11. A suitable cutout 8.5 is then provided in the first shell 8 to make a place for the longitudinal groove 23.2. The opposite lateral wall 23.22 is produced by a portion of the separation wall 22. The first electrical track 23.1 is then positioned on this wall (because the heating element 46 is mounted on the separation wall).

Similarly, a similar longitudinal groove 24.2 is provided on the second connection face 24, with a cutout 9.5 in the second shell 9 and a bottom 24.21 and two opposite lateral walls 24.22, 24.23. Due to the non-centering of the grooves, the cutout 9.5 in the second shell 9 is much less marked than the cutout 8.5 in the first shell 8.

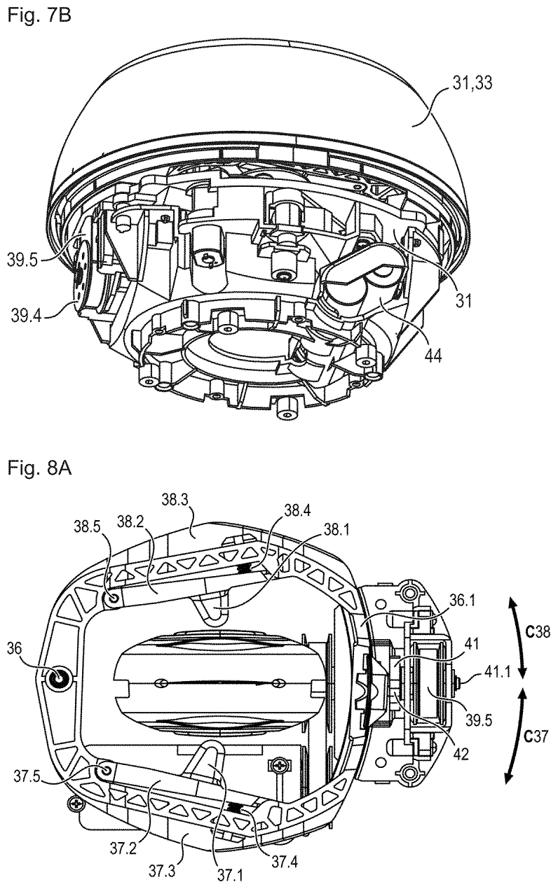

The longitudinal grooves 23.2, 24.2 are configured to be engaged on respective complementary rails 31.1, 31.2 (slide connection) provided in the receiving housing 32 on (preferably opposite) connection sides (FIGS. 1A, 7A). Consequently, the grooves 23.2, 24.2 form undercuts which extend over the entire height of the portion of the receiving device 5 where they are located — at the very least up to the height of insertion. The complementary rails 31.1, 31.2 contribute to defining the receiving housing 32 and are positioned on opposite edges.

In an embodiment visible in FIGS. 4A, 4B in particular, the electrical contact tracks 23.1, 24.1 are not located at the same level, but are offset.

The electrical contact tracks 23.1, 24.1 can take several forms: electrical pins, metal blades (as illustrated), etc. The electrical contact tracks 23.1, 24.1 are preferably slightly deformable to ensure permanent contact when the receiving device 5 is placed in the receiving housing 32.

It is thus noted that the longitudinal grooves 23.2, 24.2 are not centred with respect to the first and second actuation faces 8.1, 9.1 (see in particular FIGS. 2A, 4A, 4B). In terms of design, this results in a groove essentially formed in the first support part 11 and the first protective shell 8.

The interest in this asymmetry lies in a keying function. It is indeed impossible to put the receiving device 5 in the wrong direction (according to a 180° rotation about the longitudinal axis X) because the grooves 23.2, 24.2 would not fit into the rails 31.1, 31.2 and the second shell 9 would come into stop against them.

In order to have a misleading effect for a vertical rotation (that is to say by trying to put the removal face first instead of the insertion face), the longitudinal grooves 23.2, 24.2 do not extend over the entire height of the portion of the first or second shell 8, 9 where they are located. Consequently, without necessarily providing a specific part, a stop effect is obtained simply by the part of the shell 8, 9 which does not pass through by the undercut effect. In other words, the shell 8, 9 prevents the insertion of the grooves 23.2, 24.2 on the rails 31.1, 31.2 when the receiving device 5 is in the wrong direction.

In addition, the longitudinal grooves 23.2, 24.2 each comprise an end stop 23.3, 24.4, located on the side of the removal face. These end stops 23.3, 24.4 have a role of insertion stop, to define a maximum insertion position in the receiving housing 32.

In reality, it has two different types of stops, but they are located in substantially the same place: at the end of the longitudinal grooves 23.2, 24.2.

The electrical contact tracks of the temperature sensor

In the embodiment illustrated in the figures, the heating circuit further includes a temperature regulation circuit which comprises a temperature sensor (not visible in the figures). Advantageously, the temperature sensor is attached to the rear face of the diffusion plate 46.2 to measure the temperature prevailing near the first receiving location 13 and therefore the first capsule 3.

The temperature sensor is typically an NTC.

This temperature sensor must also be electrically connected to the mixing machine 6 (in particular ultimately the processor, to recover the data) and a battery 44 fitted to the mixing machine 6, to power it. To this end, the temperature regulation circuit comprises a first additional electrical contact track 46.51 which is provided at the first contact face 23 and which is electrically connected to the temperature sensor. This first additional electrical track 46.51 is distinct from the first electrical contact track 23.1. More precisely, the first additional electrical contact track 46.51 is provided in the first groove 23.2, on the lateral wall 23.23, that is to say the lateral wall formed by the first support part 11.

Similarly, the temperature control circuit comprises a second additional electrical contact track 46.52 which is provided in the second groove 24.2 and which is electrically connected to the temperature sensor. This second additional electrical track 46.52 is distinct from the second electrical contact track 24.1.

The two tracks 46.51, 46.52 are also advantageously offset. In a specific example, tracks 46.51 and 24.1 are at the same level and the tracks 46.52 and 23.1 are at the same level.

FIGS. 2A, 3A, 3B, 4A, 4B, 5 illustrate these tracks.

The Foolproof Device

The receiving device 5 includes a foolproof device 17 to ensure that the capsules 3.4 are correctly positioned, that is to say that the «good» capsules 3.4 are placed in the «good» receiving housings 13, 14 (distinctly visible in FIGS. 2A, 5). The foolproof device 17 is preferably located at the end of the passage openings 11.2, 12.2, to block the unwanted passage of an unwanted connection end 3.2, 4.2.

The foolproof device 17 comprises at least one leaf 17.1 opening towards the outside of the receiving device (preferably two, on each side as illustrated in the figures; preferably, the two leaves 17.1 have a saloon configuration, that is to say articulated by hinges towards the outside of the receiving device 5).

In particular, the foolproof device 17 fulfils two distinct roles.

The leaf 17.1 comprises an opening 17.2 of complementary shape to the female connection end piece 3.4 of the first capsule in order to authorize its insertion into the opening 8.2. In addition, the leaf 17.1 comprises a stop 17.3, which contributes to define the opening 17.2, in order to prevent the insertion into the opening 8.2 of the second connection part 4.2, which is longer transversely than the first connection part 3.2. Indeed, if one tries to insert the second capsule 4 into the first receiving location 13, the end of the second connection part 4.2, that is to say part of the male connection end 4.4 comes knock against the stop 17.3.

For access to the second receiving location 14, the foolproof device 17 blocks it when the receiving device 5 is in the closed position: the passage opening 12.2 is blocked, preferably by the stop 17.3 as well. On the other hand, when the receiving device 5 is in the open position, that is to say the second shell 9 has turned on its hinge, the passage opening 12.2 is released.

Finally, as the leaf 17.1 is opened outwards, it is functionally non-blocking during the extraction of the capsules 3.4 (both at the same time, since they are attached) from the receiving device 5.

The foolproof device 17 can be attached to the first support part 11 or to the second support part 12 (as in the figures), depending on the design of the relative movement of the parts: if the second support part 12 is attached to the second shell 9 (and therefore movable in rotation with respect to the first support part), then it is preferable to attach the foolproof device to the first support part 11. In other words, this is irrelevant.

Return springs 17.4 keep the foolproof device 17 in the default position, that is to say closed.

The Bearing Elements—the Pallets

As shown in particular in FIGS. 2B, 3A, 3B, 5 the receiving device 5 further includes a first bearing element 19 configured to penetrate inside the first receiving location 13, that is to say to exert a pressure force on the first capsule 3, and more particularly on the first deformable compartment 3.1, and a second bearing element 21 configured to penetrate inside the second receiving location 14, that is to say to exert a pressure force on the second capsule 4, and more particularly on the second deformable compartment 4.1.

The first bearing element 19 (respectively the second bearing element 21) is preferably mounted on the first support part 11 (respectively the second support part 12) and is displaceable between an inactive position, or so-called deployed position, in which the receiving location 13, 14 is accessible for the capsule 3, 4 (see FIG. 2B) and an active position or so-called folded position, in which the first bearing element 19 (respectively the second bearing element 21) penetrates inside the first receiving location 13 (respectively the second receiving location 14), that is to say it is able to exert a pressure force on the first deformable compartment 3.1 of the first capsule 3 (respectively the second deformable compartment 4.1 of the second capsule 4).

The first bearing element 19 (respectively the second bearing element 21) is advantageously mounted in rotation about a hinge 19.1 (respectively the hinge 21.1). The hinge 19.1 (respectively the hinge 21.1) is located opposite the opening 8.2 (respectively the hinge 8.1) of the first shell 8 (respectively the second shell 9). The hinges 19.1, 21.1 are therefore both located close to the removal face of the insertion device 5.

The bearing elements 19, 21 each have a flat internal face 19.2, 21.2 to form movable in rotation pallets. Each flat internal face 19.2, 21.2 cooperates with its respective capsule. As you press on the bearing elements, the volume between the pallet and the placement surface 11.1, 12.1 gradually and continuously decreases. When a capsule is installed, the outlet orifice 3.6 and the connection parts 3.2, 4.2 are located on the side opposite the hinge 10: this allows the cream to be expelled effectively from the capsule while avoiding any unwanted retention zone therewithin.

To hold the bearing elements 19,21 in the open position by default (that is to say when the receiving device 5 is not actuated or when the second shell 9 is in the pivoted position), return means 21.3, as springs, are provided, bearing against the shell 8, 9 (FIG. 5). The return means 21.3 may tend to push the pallet which extends slightly on the other side of the hinge 21.1.

In use, as will be described later, the two bearing elements 19, 21 are successively activated to allow the kneading of the cream. The cream then passes from one capsule 3,4 to the other capsule 4,3.

Preferably, to optimize the operation of the pallet, the hinge 19.1 (respectively the hinge 21.1) defines an axis of rotation comprised in the plane of the placement surface 11.1 (respectively the placement surface 12.1) and orthogonal to the longitudinal axis of the receiving device 5.

In the absence of a capsule, the internal face 19.2, 21.2 can be pressed against the placement surface 11.1, 12.1.

Similarly, the hinge 19.1, 21.1 is preferably located just at the end of the receiving location.

In order to displace the bearing elements 19, 21, the first and second shells 8, 9 each comprise, preferably opposite the end part of the pallet (to take advantage of the leverage effect and minimize the effort to be applied), a bearing point 8.3, 9.3, configured to receive an external force, described in more detail below. The bearing point 8.3, 9.3 is attached to a flexible zone 8.4, 9.4, that can be deformed (in elastomer, etc.). The flexible zone 8.4, 9.4 is itself attached to the rest of the shell 8, 9, made from a more rigid plastic.

The bearing point 8.3, 9.3 is made of a rigid material (typically plastic).

Alternatively (not illustrated), the first and second shells 8, 9 have two orifices, preferably opposite the end part of the pallet, in order to allow free access to the bearing elements 19, 21.

A user can, with one hand, grasp the receiving device 5 and bear the bearing points 8.4, 9.4 simultaneously, for example with the thumb and the index/middle finger. Simultaneous pressure allows directing the cream from the two capsules 3, 4 towards the outlet orifice 3.6.

The Retention Stop

In order to prevent the receiving device 5 from being removed from the receiving housing 32 when the mixing method is in progress, a retention mechanism 50, described in detail later, is provided in the manufacturing apparatus.

For the retention mechanism 50 to have a grip on the receiving device 5, a retention stop 9.6 is provided on one of the two shells 8.9 (the second shell 9 in

FIGS. 2A, 2B, 3A, 3B, 4B, 5). This retention stop 9.6 essentially corresponds to a projection extending radially, that is to say in a plane orthogonal to the longitudinal direction X. It can be at any location along the height of the receiving device 5. In the illustrated embodiment, the retention stop 9.6 is arranged close to the insertion face.

Another stop may be provided on the other shell, for ergonomic reasons, for example.

The Gripping Handles

In order to allow the user to grab the receiving device 5 when it is inserted into the receiving housing 32, gripping handles 8.7, 9.7 are provided on each protective shell 8, 9 (visible in particular in the FIGS. 1, 2B, 4A, 4B). These gripping handles 8.7, 9.7 are located at the level of the removal face, which is the one accessible when the receiving device 5 is in place.

The gripping handle 8.7, 9.7 can simply be constituted by a projection extending radially, that is to say in a plane orthogonal to the longitudinal direction X, long enough for part of the user phalanx can shoot it.

The Coupling Button

As indicated previously, the actuation faces 8.1, 9.1, and more specifically the first and second protective shells 8, 9 each include a bearing point 8.3, 9.4, to transfer the force to the bearing elements 19, 21 inside. These bearing points 8.3, 9.4 are formed in a flexible zone 8.4, 9.4.

When the receiving device 5 passes into the closed position, the connection end pieces 3.4, 4.4 come opposite each other and partially fit together.

To create sealed and reliable fluid communication between the two capsules 3, 4, a coupling mechanism 52 is provided in the manufacturing apparatus. This coupling mechanism 52 exerts a force in the direction of the receiving device 5. This coupling mechanism 52 makes it possible both to establish the fluidic connection between the two capsules 3,4 under the effect of the force exerted by the coupling mechanism 52 but also to avoid any unwanted disconnection of the first and second capsules 3.4 under the effect of the pressures generated by the mixing of the first and second capsules 3.4. It will be described later.

One of the two protective shells 8, 9 (or even both), comprises a coupling button 9.8, movable in the direction of the second receiving location 14 (FIGS. 2A, 2B, 3A, 3B, 4A, 4B, 5). More precisely, it is movable in the direction of a zone close to the opening 9.2, since the coupling button 9.8 is intended to press on the second capsule 4 close to the connection portion 4.2. In this regard, the coupling button 9.8 is attached to a flexible zone, which may be the flexible zone 9.4 of the bearing point 9.3. It is noted here that the coupling button 9.8 is distinct from the bearing point 9.3.

The coupling button 9.8 is preferably rigid to better transmit the force of the coupling mechanism 52 to the first and second capsules 3, 4, which are therefore kept coupled.

The Mixing Machine

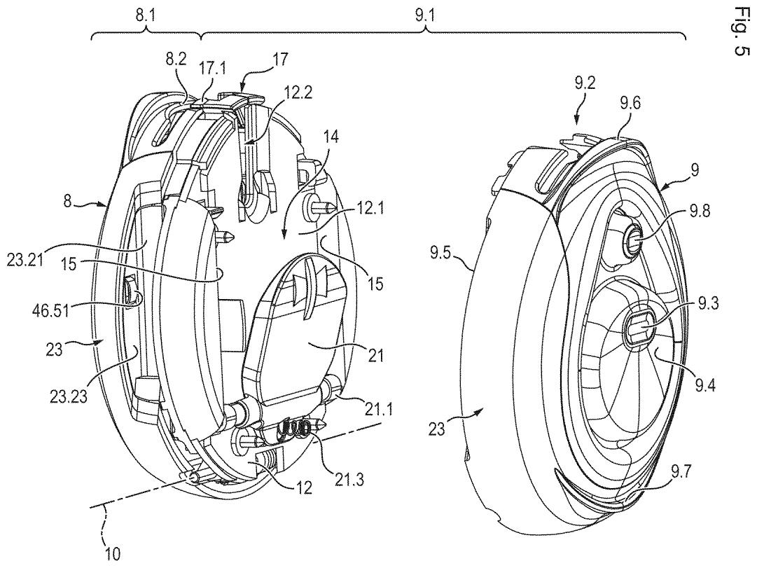

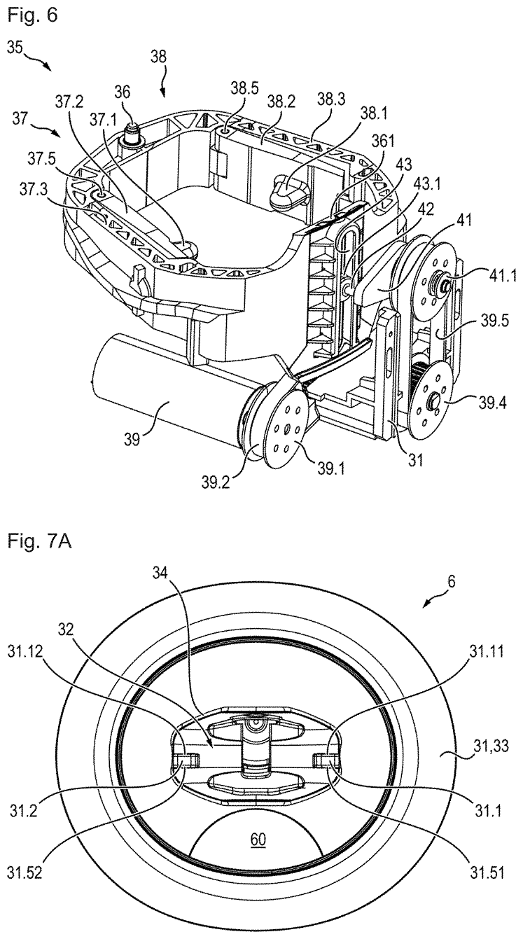

As shown more particularly in FIGS. 6, 7A, 7B, 8A, 8B, 8C, 9, 10A, 11A, 11B, 11C, the mixing machine 6 includes a support 31, and a receiving housing 32 defined at least in part by the support 31 and configured to at least partly receive the receiving device 5. According to the embodiment represented in FIGS. 1A, 1B, the mixing machine 6 and the receiving device 5 are configured such that the receiving device 5 extends at least partly outside the mixing machine 6, when the receiving device 5 is received in the receiving housing 32.

The support 31 acts as a base, that is to say it defines a set of fixed elements when the mixing machine 6 is placed on a support, regardless of whether it is in use or not.

The support 31 of the mixing machine 6 also includes an outer shell 33 and an insertion opening 34 opening into the receiving housing 32, the receiving device 5 being configured to be inserted into the receiving housing 32 through the insertion opening 34.

Advantageously, the insertion opening 34 is formed in a central portion of an upper surface of the base 33 and is configured to be oriented upwards when the mixing machine 6 is placed on a horizontal support surface.

The base 33 also acts as an outer casing, with the desired design for the mixing machine. The base 33 may comprise a lower base and an upper base.

The Actuation System

The mixing machine 6 further includes an actuation system 35 pivotally mounted on the support 31 about a substantially vertical pivot axis 36 when the mixing machine 6 is placed on a horizontal support surface (FIGS. 6, 8A, 8B, 8C, 9, 10A).

Preferably, the actuation system 35 performs back and forth movements about the pivot axis 36 according to a maximum angular deflection of 45°. The movement is therefore composed of a rotation at +45° C. maximum then a rotation at −45°, and so on. Its movement takes place according to a nominal stroke C35 (not represented in the figures), which, in the case of the rotation about the pivot axis 36, is associated with the maximum angular movement. The nominal stroke C35 of the actuation system 35 is defined as the stroke between two extreme positions of said actuation system 35. A neutral position of the actuation system 35 is defined between these two extreme positions, the neutral position of the actuation system 35 corresponding to an insertion position in which the receiving device 5 can be positioned inside the receiving housing 32 of the mixing machine 6 without being hindered by the actuation system 35.

The mixing machine 6 further includes a driving motor 39 mounted on the support 31. The driving motor 39 is configured to pivot the actuation system 35 about the pivot axis 36 and in a predetermined angular range. Preferably, the driving motor 39 only rotates in one direction.

The actuation system 35 includes a first actuation member 37, which may comprise a first actuation finger 37.1, configured to transmit a pressure force to the first capsule 3, and a second actuation member 38, which may comprise a second actuation finger 38.1, opposite to the first actuation member 37 and configured to transmit a pressure force to the second capsule 4.

The first and second actuation members 37, 38 are configured to be arranged on either side of the receiving housing 32 and therefore of the receiving device 5 when the latter is received in the mixing machine 6, and more precisely in the receiving housing 32.

The actuation members 37, 38 have at least one position in which they are at least partially inside the receiving housing 32. In the neutral position of the actuation system 35, the actuation members 37, 38 are arranged with respect to the receiving housing 32 so as to allow the receiving device 5 to be positioned inside the receiving housing 32 of the mixing machine 6; this is the insertion position.

The first and second actuation members 37, 38 are more particularly configured to exert pressure forces respectively and alternately on the first and second bearing elements 19, 21, so as to transmit pressure forces respectively and alternately on the first and second compartments 3.1, 4.1. In particular, the first and second actuation members 37, 38 are configured to cooperate respectively with the first and second bearing points 8.3, 9.3 of the first and second protective shells 8, 9, or directly on the bearing elements 19, 21.

An actuation stroke C37 is defined for the first actuation device 37 and an actuation device stroke C38 for the second actuation device 38.

The actuation stroke C37 is defined as the stroke of the first actuation member 37 between the neutral position of the actuation system 35 and the maximum actuation position of the first actuation member 37, in which the first actuation member 37 is in maximum compression on the first bearing element 19.

Conversely, the actuation stroke C38 is defined as the stroke of the second actuation member 38 between the neutral position of the actuation system 35 and the maximum actuation position of the second actuation member 38, in which the second actuation member 38 is in maximum compression on the second bearing element 21.

According to the embodiment represented in FIGS. 1 to 22, the first and second actuation members 37, 38 extend substantially in the same extension plane, and converge opposite the pivot axis 36.

As illustrated in FIGS. 6, 8A, 8B, 8C, 9, the actuation system 35 has a substantially annular shape defining an opening around the receiving housing 32. In an embodiment, the actuation system 35 is substantially formed of one part, comprising an opening to receive a shaft defining the pivot axis 36.

The first actuation member 37 and the second actuation member 38 are each arranged on opposite sides of the actuation system 35. Consequently, there is an actuation system 35 extending twice over two faces opposite in pairs: the actuation devices 37, 38, the opening for the pivot axis 36 and the driving mechanism with groove which is described later.

The actuation members 37, 38 can each comprise a driving support 37.3, 38.3, which meet on one side at the level of the pivot axis 36. On the other side, a connection portion 36.1 is defined, which connects the two driving supports 37.3, 38.3. The connection portion 36.1 can be attached or made in one piece with the driving supports 37.3, 38.3.

Preferably, the two actuation devices 37, 38 rotate about the same pivot axis 36. In this case, preference is given to two secured in rotation driving supports 37.3, 38.3.

Nonetheless, it is possible to provide a pivot axis for each of the actuation devices 37, 38; nonetheless, some simple adaptations will have to be made.

Alternatively, in an embodiment not shown, the actuation devices are movable in translation.

The Springs

The actuation system 35 moves along a nominal stroke C35 to exert a force on the receiving device 5.

Nevertheless, the clearances in the kinematic chain, related to manufacturing tolerances, can disrupt the transmission of forces by shifting the positioning of the actuation system 35. Thus, once at the end of its stroke, it may be that a few millimeters are missing or conversely that there are a few extra millimeters. This can cause insufficient compression or conversely break the manufacturing apparatus.

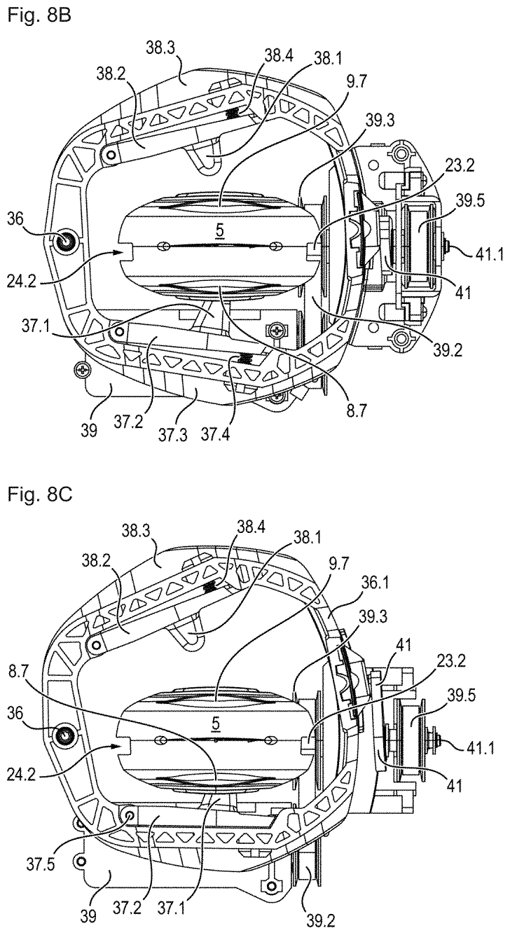

To overcome this, the actuation system 35 may comprise a spring 37.4, 38.4 (particularly visible in FIGS. 8A, 8B, 8C). In particular, the spring 37.4, 38.4 is configured to be compressed when the actuation system 35 reaches the vicinity of its nominal end of stroke C35 and the actuation finger 37.1, 38.1 abuts against the flat face 3.7,4.7 of the capsule. The spring 37.4, 38.4 therefore generates a force tending to separate the actuation member 37, 38 from the receiving device 5.

More specifically, each actuation member 37, 38 comprises a spring 37.4, 38.4.

The spring 37.4, 38.4 can be located in different places. In an embodiment not illustrated, the spring 37.4, 38.4 is located at the «freeD end of the finger 37.1, 38.1.

In another embodiment, preferred because the spring is hidden, the spring 37.4, 38.4 is mounted between the finger 37.1, 38.1 and the driving support 37.3, 38.3. In this way, the user cannot access it because the spring is behind the base.

To put the spring in this place, it is convenient to provide for each actuation member 37, 38 an arm 37.2, 38.2, movably mounted relative to the driving support 37.3, 38.3. The finger 37.1, 38.1 is then securely mounted with the arm 37.2, 38.2.

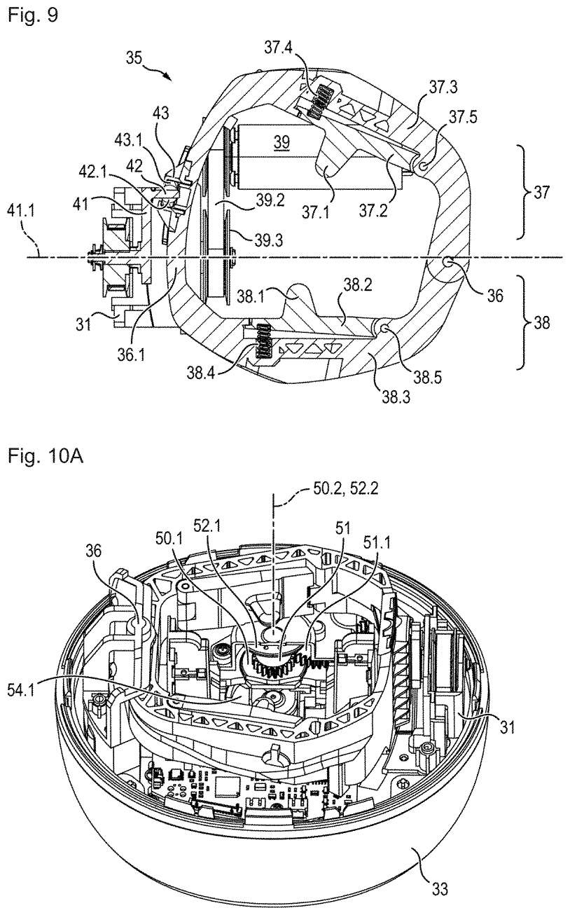

In the embodiment illustrated in particular in FIGS. 8A, 8B, 8C, 9, the arm 37.2, 38.2 is movable in rotation relative to the driving support 37.3, 38.3 by a hinge 37.5, 38.5. The spring 37.4, 38.4 is positioned between the arm 37.2, 38.2 and the driving support 37.3, 38.3.

The spring 37.3, 38.3 therefore works in compression, in the sense that its empty position, or unconstrained position, is not compressed. It is compressed in the direction of translation or rotation of the actuation device 37, 38.

The spring 37.3, 38.3 can be of the helical, leaf type, or even comprise an elastic material or an elastic assembly (elastomer, gas bubble, etc.).

The Driving in Rotation

According to the embodiment represented in FIGS. 6, 8A, 8B, 8C, 9, the mixing machine 6 also includes a cam 41, in the form of a driving wheel or an arm, secured in rotation to an output shaft 39.1 of the driving motor 39 and configured to be driven in rotation about its cam rotation axis 41.1. The cam 41 is mounted on the support 31.

To authorize the back-and-forth movement with a large lever arm, it is preferable that the pivot axis 36 and the cam 41 are on either side of the receiving housing 32.

The cam 41 is equipped with a driving finger 42 which is eccentric with respect to the cam rotation axis 41.1.

The cam 41 is typically driven by the driving motor 39 using one or more belts. In this case the kinematic chain is as follows, from the driving motor 39 and its output shaft 39.1 on which a pulley is mounted: a belt 39.2, a pulley 39.3 connected to a pulley 39.4 by a shaft, a belt 39.5, the cam 41.

The driving finger 42 is received in a driving groove 43 provided on the actuation system 35. In particular, the driving groove 43 is built into the connection portion 36.1. The driving groove 43 is elongated and extends along a direction of extension substantially parallel to the pivot axis 36. Such a configuration of the mixing machine 6 makes it possible to obtain an alternating movement of the actuation system 35 by making the driving motor 39 always rotate in the same direction of rotation, so that it is not necessary to resort to an expensive control system of the driving motor 39.

The driving groove 43 extends, according to its depth, in the direction of the pivot axis 36.

Now, the connection between the driving groove 43 and the driving finger 42 will be described. Given the rotation of the actuation system 35, the alignment of the driving groove 43 and the driving finger 42 is variable, which means that a simple adjustment would block the system. Conversely, the presence of a clearance, which would allow misalignment, generates noise and gives a delay time at each stroke end.

To solve this, a ball joint is provided between the driving finger 42 and the driving groove 43, which makes it possible to manage the previous misalignment.

In particular, on the driving finger 42 is mounted a ball 42.1, which is housed in a ring 43.1. The connection between the ball 42.1 and the ring 43.1 is a ball joint. The ring 43.1 is received in the driving groove 43 where it is movably mounted in translation in a direction parallel to the pivot axis 36 (therefore along the length of the driving groove 43). Finally, the ball 42.1 is movably mounted in translation along the driving finger 42.

The arrangement of these different connections can be different, in the sense that the ring can also be movable in translation along the depth of the groove and the ball is then fixed on the driving finger.

Consequently, the complete connection between the driving finger 42 and the actuation system 35 comprises in series a slide, a ball joint, a slide perpendicular to the other slide. Consequently, in a kinematic torsor, it is noted that the force is only transmissible on one of the six components of the torsor, namely that of the tangent translation to the rotational movement of the actuation system 35, that is to say the one which allows the rotation of the actuation system 35. The kinematic equivalent is the sphere-plane connection (also called point connection).

So that the connection described above is not unnecessarily more complex, the cam rotation axis 41.1 and the pivot axis 36 are preferably orthogonal. This makes it possible to have a driving finger 42 which describes a circular movement in a plane parallel to the pivot axis 36.

Certain provided movements in the connections can be done simply by plastic/plastic sliding, whose wear is sufficiently slow to ensure a satisfactory lifespan.

According to a variant of the invention, the mixing machine 6 could be configured such that a rotation of the driving motor 39 in a first direction of rotation causes a pivoting of the actuation part 35 in a first pivoting direction and that a rotation of the driving motor 39 in a second direction of rotation, opposite to the first direction of rotation, causes the actuation part to pivot in a second pivoting direction, opposite to the first pivoting direction.

Decentering of the Pivoting Axis

The actuation devices 37, 38 are each displaced along an actuation stroke C37, C38.

Nevertheless, in the embodiment illustrated in the figures, one of the two actuation members 37, 38 has an actuation stroke C37, C38 of a length strictly greater than that of the other actuation member.

This difference in actuation stroke C37, C38 makes it possible to better manage mechanically and electrically the effort to be provided to deform the first capsule 3 with respect to the second capsule 4. Indeed, as illustrated in FIG. 2B, the first capsule 3 has a greater thickness than the second capsule 4, which means that more space is needed on the side of the thicker capsule and that the bearing element 19 will be in contact more quickly and will start working more quickly than the bearing element 21.

To achieve this difference in stroke, several solutions are possible.

One solution is to have a driving groove 43 not centered in the connection portion 36.1.

Another solution, illustrated in particular in FIGS. 8A, 8B, 8C, 9 consists in decentering the pivoting axis 36. In other words, the cam rotation axis 41.1 does not intersect with the pivot axis 36. This induces a difference in stroke between the two actuation members 37, 38 when the cam 41 makes a complete turn. A distance (orthogonal, that is to say by orthogonal projection) between the cam rotation axis 41.1 and the pivoting axis 36 of 1% to 5% of the distance between the driving groove 43 and the pivoting axis 36 is sufficient and does not disturb the symmetrical appearance of the whole. In absolute terms, a distance comprised between 1 and 2 mm is suitable.

The decentering can also be defined using the receiving housing 32 with respect to the cam rotation axis 41: thus the extreme positions of the actuation system 35 are not centered about the receiving housing 32.

The decentering can also be defined relative to the first and second placement surfaces 11.1, 12.1 or relative to the location of the first and second capsules 3, 4 within the receiving housing 32: using the flat faces 3.7, 4.7, which therefore define artificial planes in the receiving housing 32. The maximum distance from the first actuation member 37 to said plane of the flat face 3.7 is greater than the maximum distance of the second actuation member 38 relative to the flat face 4.7.

In this regard, in a variant, the pivot axis 36 is comprised in a plane located equidistant from the two placement surfaces 11.1, 12.1.

In reaction to the decentering, the first actuation finger 37.1 is advantageously longer than the second actuation finger 38.1. This is in particular due to the fact that it is necessary to compensate for the extreme position of the actuation fingers 37.1, 38.1 due to the decentering. More precisely, the actuation finger 37.1, 38.1 which works on the thickest capsule 3, 4, has a greater length than the other actuation finger 38.1, 37.1.

Another solution, which is illustrated in FIG. 8A, consists in not defining the neutral position of the actuation system 35 during a top or bottom dead center of the cam 41. Indeed, by choosing the neutral position of the actuation system 35 at a non-zero angle Ag (typically Ag is comprised between 5° and 30°) with respect to noon (when the mixing machine 6 is placed on a horizontal support), the distribution of the actuation strokes C37, C38 is shifted. It is also noted that it is actually obtained another neutral position for an angle Ag′ corresponding to Ag′=180°-Ag.

Indeed, the actuation strokes C37, C38 correspond, at the level of the cam 41, to the rotation from said angle Ag to the nearest 90° rotation (that is to say 3 o'clock or 9 o'clock, when the mixing machine 6 is placed on a horizontal support) and then to the rotation from the said angle Ag′ until the rotation at 270°.

As Ag and Ag′ are not at 0 and 180° (noon and 6 o'clock), it is immediately noticed that the strokes C37 and C38 are not equal. On a complete rotation of the cam 41, the first actuation stroke C37 has therefore been traversed in a first direction then the first actuation stroke C37 in a second direction, then the second actuation stroke C38 in a first direction then the first actuation stroke C38 in a second direction, that is to say twice the nominal stroke C35.

Mixing Machine Contact Tracks

As previously mentioned, the mixing machine 6 also comprises electrical contact tracks 31.11, 31.12 configured to be engaged with the electrical contact tracks 23.1, 24.1 of the longitudinal grooves 23.2, 24.2 of the receiving device 5 and the electrical contact tracks 31.51, 31.52 configured to be engaged with the electrical contact tracks 46.51, 46.52 of the longitudinal grooves 23.2, 24.2. These electrical contact tracks are mounted on the rails 31.1, 31.2 (FIGS. 1A, 7A), which are secured to the support 31 and which are mounted on two connection sides of the receiving housing 32. The location of the electrical contact tracks 31.11, 31.12 (and also 31.51, 31.52) on the rails 31.1, 31.2 is complementary to the location of the electrical contact tracks 23.1, 24.1 (and also 46.51, 46.52) of the connection faces 23, 24 of the receiving device 5. The rails 31.1, 31.2 contribute to define the receiving housing 32. They are for example located on the edge and are preferably fixed over their entire length to the support 31.

The location of the electrical contact tracks 31.51, 46.51 and 31.52, 46.52 on two opposite rails 31.1, 31.2, located at a distance from each other, has the advantage of limiting the risks of short-circuit if ever liquid were to sink by gravity on one of the rails 31.1, 31.2.

Closing, Coupling, Removal Mechanism

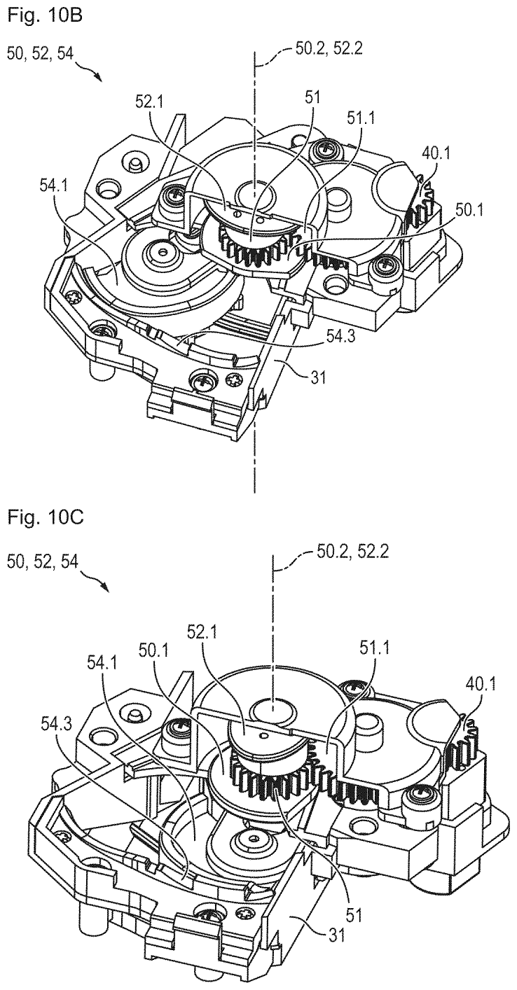

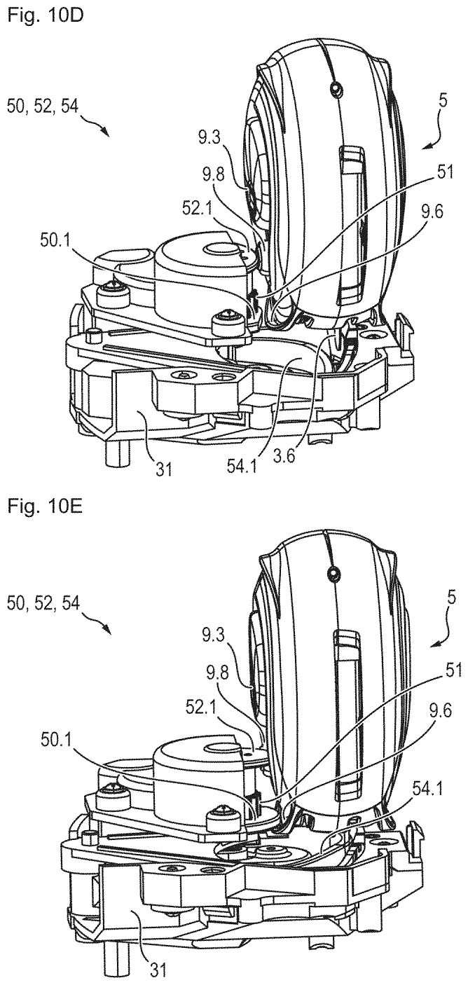

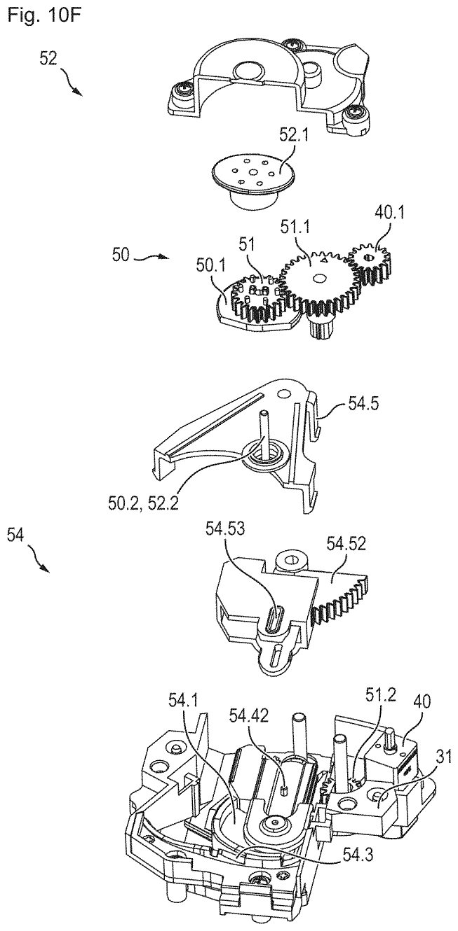

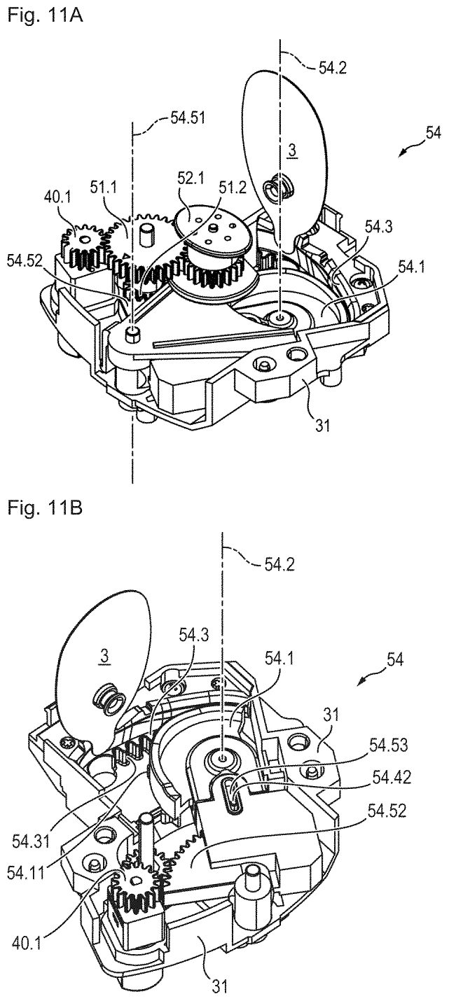

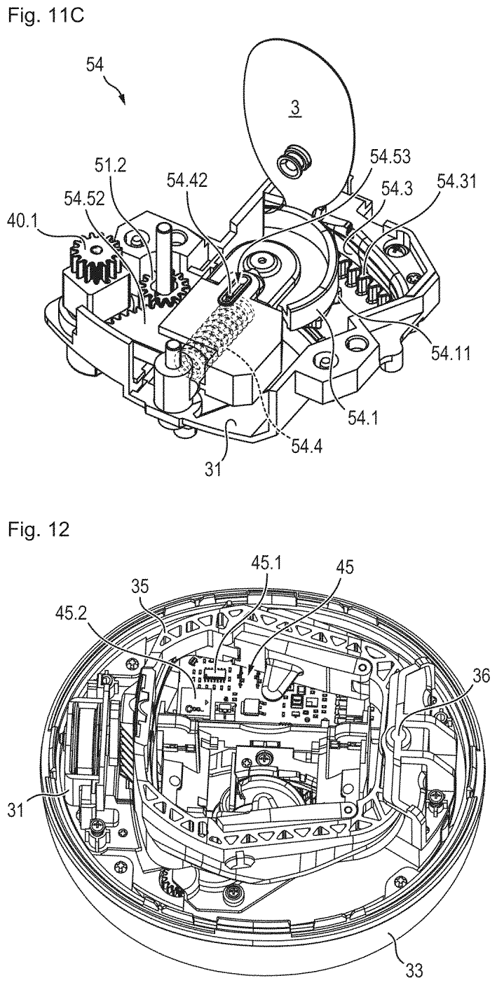

The mixing machine 6 further comprises a retention mechanism 50, a coupling mechanism 52 and a clamping mechanism 54 (FIGS. 10A, 10B, 10C, 10D, 10E, 10F, 11A, 11B, 11C).

Each of these mechanisms has its own independent function. However, they can advantageously be driven simultaneously by the same auxiliary motor 40.

The function of the retention mechanism 50 is to prevent the removal of the receiving device 5 when the mixing is in progress.

The retention mechanism 50 is movably mounted relative to the support 31 between an insertion position and a retention position. In the insertion position, the retention mechanism 50 allows the insertion and removal of the receiving device 5 relative to the mixing machine 6. In the retention position, the retention mechanism 50 blocks the removal of the receiving device 5 (and therefore would prevent its insertion).

The retention mechanism 50 comprises a movable element 50.1 between the two aforementioned positions, which extends into the receiving housing 32 in the retention position. In particular, in the retention position, the movable element 50.1 cooperates with the retention stop 9.6 to prevent a translational movement of the receiving device 5 aimed at extracting it from the mixing machine 6 (in fact, the retention stop 9.6 is blocked against the movable element 50.1 in the event of the removal). In this respect, the movable element 50.1 and the retention stop 9.6 are provided to be located close in the retention position, preferably less than 2 mm, when the receiving device 5 is placed in the mixing machine.

In an embodiment illustrated in FIGS. 10A, 10B, 10C, the movable element 50.1 is a wheel, called retention wheel, movable about a wheel rotation axis 50.2. The wheel 50.1 has at least two different spokes, the smaller spoke being configured not to extend into the receiving housing 32 in the insertion position and the larger spoke being configured to extend into the receiving housing 32 in the retention position, so to come into contact, in the event of removal, against the retention stop 9.6.

The wheel 50.1 is preferably circular with a flat portion, the flat portion allowing the insertion position.

The wheel 50.1 is mounted on a shaft which extends along the axis of rotation of the wheel 50.2. This shaft comprises a pinion 51 or a pulley, connected to at least one other pinion or another pulley 51.1.

Alternatively, the movable element 50.1 is movable in translation, for example by a rack and pinion system using the pinion 51.

The function of the coupling mechanism 52 is to establish the sealed connection between the two capsules 3, 4 and to ensure that the two capsules 3, 4 remain well fitted via their connection end piece 3.4, 4.4 by pressing the coupling button 9.8 of the second protective shell 9.

The coupling mechanism 52 is movably mounted relative to the support 31 between an insertion position and a coupling position. In the insertion position, the coupling mechanism 52 allows the insertion and removal of the receiving device 5. In the coupling position, the coupling mechanism 52 locks the two capsules 3, 4.

The coupling mechanism 52 comprises a coupling element 52.1 movable between the two aforementioned positions, which extends into the receiving housing 32 in the coupling position. In particular, in the coupling position, the coupling element 52.1 cooperates with the coupling button 9.8 which is displaced inside the second receiving location 14. In this respect, the coupling element 52.1 and the coupling button 9.8 are located opposite, when the receiving device 5 is placed in the mixing machine 6.

In an embodiment illustrated in FIGS. 10A, 10B, 10C, the coupling element 52.1 is a wheel, called a coupling wheel, movable about an axis of rotation of a wheel 52.2, which preferably coincides with the wheel rotation axis 50.2. The wheel 52.1 has at least two different radii, the smaller radius being configured so as not to extend into the receiving housing 32 in the insertion position and the larger radius being configured to extend into the receiving housing 32 in the coupling position, in order to come into contact with the coupling button 9.8, and to press it.

The wheel 52.1 is preferably oval in plan.

The wheel 52.1 is mounted on a shaft which extends along the axis of rotation of the wheel 52.2. This shaft comprises a pinion or a pulley, connected to at least one other pinion or another pulley 51.1. The shaft and the pinion are preferably the same as the shaft and the pinion 51. A first subassembly secured in rotation is thus obtained.

Alternatively, the coupling element 52.1 is movable in translation, for example by a rack and pinion system using the pinion 51.

The coupling mechanism 52 is separate from the actuation system 35. This results in a different position in the mixing machine 6 (for example at different heights). Similarly, the receiving device 5 indeed comprises bearing points 8.3, 9.3 distinct from the coupling button 9.8.

The clamping mechanism 54 has the function of blocking the outlet passage 3.5 of the first capsule 3 when the mixing method is in progress. Indeed, the pressures inside the capsules could cause an unwanted exit of the cream. In this case, cream would spill into the mixing machine 6, which is to be avoided. It is illustrated in FIGS. 11A, 11B, 11C.

The clamping mechanism 54 is movable relative to the support 31 between an insertion position and a clamping position. In the insertion position, the clamping mechanism 54 allows the insertion and removal of the receiving device 5 carrying the first capsule 3. In the clamping position, the clamping mechanism 54 clamps the outlet passage 3.5.

The clamping mechanism 54 comprises a wheel 54.1, called the clamping wheel, which is movable in rotation about a clamping wheel axis 54.2.

The mixing machine 6 further comprises a guide wall 54.3, fixed (secured to the support 31, or even integral with the latter), against which the clamping wheel 54.1 rolls or slides, and a clamping wall against which it is clamped in the clamping position. The clamping wall is advantageously a portion of the guide wall 54.3. There are several variants: a variant in which the clamping wheel 54.1 approaches the guide wall 54.3 in the direction of the clamping position, a variant in which the distance is constant or variant in which the clamping wall has a particular concavity, to trap the clamping wheel 54.1 (this is possible thanks to a clamping wheel 54.1 movable in translation — see below).

The teeth 54.11 present on the clamping wheel 54.1 (in practice the wheel comprises a circular or substantially circular portion which pinches the first capsule 3 and a toothed portion, preferably under the circular portion) can cooperate in the teeth 54.31 in the guide wall 54.3, so that the clamping wheel 54.1 rolls against the guide wall 54.3. In addition, thanks to the teeth 54.11, 54.31, the clamping wheel 54.1 has a rolling movement without slipping against the guide wall 54.3, which makes it possible to avoid slippage which could badly pinch the outlet passage 3.5.

Finally, thanks to the teeth 54.11, 54.31, the distance between the clamping wheel 54.1 (except the teeth, that is to say the average distance) and the guide wall 54.3 can be reduced to become almost zero under the first capsule 3 while keeping a rolling movement against the guiding wall 54.3.

To authorize this kinematics, the clamping wheel 54.1 is mounted, preferably movably mounted in rotation, on an arm 54.5, which is itself movable in rotation about an axis of rotation of the arm 54.51.

The arm 54.5 is secured to a pinion (or a pulley), or a portion of pinion 54.52, which is itself connected by various pinion or pulley to the common pinion 40.1. Consequently, the arm 54.5 is driven in rotation by the same auxiliary motor 40.

In order to ensure pinching in the clamping position, including when the auxiliary motor 40 is no longer energized, the clamping wheel 54.1 is movably mounted in translation radially along the arm 54.5. Return means 54.4 arranged between the clamping wheel 54.1 and the arm 54.5 tend to move the clamping wheel 54.1 away from the axis of rotation of the arm 54.51 and therefore to press the clamping wheel 54.1 against the guide wall 54.3. More specifically, an intermediate support 54.41, which carries the axis of rotation 54.2 of the clamping wheel 54.1 is provided. It is movable in translation relative to the shaft 54.5. A sliding connection with a pin 54.42 in the intermediate support 54.41 which slides in a groove 54.53 of the shaft 54.5 makes it possible to guide the translation and also, advantageously, to limit the movement of translation.

The return means 54.4 therefore operate in compression, insofar as by default they are not compressed (or only slightly). A coil spring, leaf spring, or other types of springs may be suitable.

Due to the return means 54.4, the clamping wheel 54.1 can remain pressed against the guide wall 54.3 even though the distance between the guide wall 54.3 and the axis of rotation of the arm 54.51 is variable (it can decrease towards the area where the outlet passage 3.5 is located).

The Common Driving

Preferably, the retention mechanism 50, the coupling mechanism 52 and the clamping mechanism 54 are concomitantly driven, by a common driving, as described according to the example embodiment below.

The retention mechanism 50 is driven by a pinion 51, connected at least to another pinion 51.1 (FIGS. 10A, 10B).

The coupling mechanism 52 is driven by a pinion, connected at least to another pinion, which are preferably pinion 51 and the other pinion 51.1 (FIGS. 10A, 10B).

The clamping mechanism 54 is driven by a pinion portion 54.52.

Different kinematic chains can be provided but a common pinion 40.1 is preferably provided, which then drives the other pinion 51.1 and the pinion portion 54.52.

As illustrated in FIGS. 11A, 11B, 11C, the common pinion 40.1 is located on the output shaft of the auxiliary motor 40. It directly meshes the pinion 51.1 which is mounted on a shaft comprising another pinion 51.2. This pinion 51.2 engages the pinion portion 54.52. Thus, a very simple kinematic chain, with a minimum of sprockets, and therefore a minimum of pinions by friction, a minimum of risks of breakage, and with little clearance is obtained.

Thanks to this common pinion 40.1, located on the output shaft of the auxiliary motor 40, at least two of the three aforementioned mechanisms 50, 52, 54 are simultaneously in the insertion position or in the respectively retention, coupling, clamping position. The same auxiliary motor 40 therefore drives all three, which constitutes a major simplification of the mixing machine 6 and of its operating logic.

Visual and Sound Display

The mixing machine 6 advantageously comprises a screen 60 and/or a loudspeaker, which make it possible to exchange information with the user (FIGS. 1A, 1B, 7).

The screen 60 is preferably tactile, to avoid providing physical buttons. It allows the user to indicate the start of the cycle and the removal time.

The screen 60 can also display the end of the cycle, for example being accompanied by an audible warning.

Detection Device

The manufacturing apparatus 2 further includes a detection device configured to detect the presence of the receiving device 5 in the receiving housing of the mixing machine 6.

Advantageously, the detection device is configured to detect the presence of the receiving device 5 in the receiving housing of the mixing machine 6 by detecting electrical continuity between the electrical contact tracks 46.51, 46.52 provided on the receiving device 5 and the electrical contact tracks 31.51, 31.52 provided on the mixing machine 6.

In the embodiment illustrated in the figures, the detection device is formed by a control unit 45 which is described below.

According to a variant, the detection device could be configured to detect the presence of the receiving device 5 in the receiving housing 32 of the mixing machine 6 by detecting electrical continuity between the electrical contact tracks 23.1, 24.1 provided on the receiving device 5 and the electrical contact tracks 31.11, 31.12 provided on the mixing machine 6.

Thus, it is possible to detect the presence of the receiving device 5 in the receiving housing 32 without having recourse to a specific sensor (for example mechanical), which makes it possible to propose a simple, inexpensive and reliable solution for improving use security of the mixing machine 6 as mentioned above. Indeed, if the presence of the receiving device 5 in the receiving housing 32 is not detected by the detection device, the starting of the mixing machine 6 can be prohibited, and in particular any movement of the prohibited actuation system 35, thus limiting any risk of pinching the user fingers.

According to another alternative embodiment, the detection device could be configured to detect the presence of the receiving device 5 in the receiving housing 32 of the mixing machine 6 as a function of the temperature measured by the temperature sensor.

Nonetheless, according to yet another alternative embodiment, the detection device could comprise a mechanical, optical or capacitive sensor provided on the mixing machine 6, and more particularly in the bottom of the receiving housing 32.

Power Supply and Control Unit

According to an embodiment of the invention, the mixing machine 6 also includes an electrical power source (not represented in the figures) configured to electrically supply the mixing machine 6, and in particular the driving motor 39 and the auxiliary motor 40. The electrical power source advantageously, or even exclusively, comprises at least one rechargeable battery 44 (FIG. 7B). In the illustrated example, the rechargeable battery 44 advantageously consists of a two-cell lithium-ion battery providing a nominal output voltage of 7.4 V.

As illustrated in FIG. 12, the mixing machine 6 further includes a control unit 45, comprising for example a controller such as a microcontroller or processor 45.1 such as a microprocessor, configured to control the operation of the manufacturing apparatus 2, and more particularly of the driving motor 39, the auxiliary motor 40, the heating element 46, the temperature sensor and the screen 60 (for this last, a processor is preferred), as well as any sound or visual device.

The control unit 45 advantageously comprises a memory 45.2, of the non-volatile type, which stores the lines of instructions in the form of a program to be executed by the controller or the processor 45.1, in particular to implement certain steps described in the method below.

The control unit 45 is more particularly configured to activate the driving motor 39, and therefore to control movements of the first actuation member 37 and of the second actuation member 38, only if the detection device has detected the presence of the receiving device 5 in the receiving housing 32. These provisions make it possible in particular to avoid a pinching of a finger of a user in the event of the absence of the receiving device 5 in the receiving housing 2.

When the coupling mechanism 52 is activated by the control unit 45 with a view to make a connection of the first and second connection parts 3.2, 4.2 of the first and second capsules 3, 4, and more precisely when activation of the auxiliary motor 40 associated with the coupling mechanism 52 (which may be different from the axillary motor associated with the retention mechanism 50 and the clamping mechanism 54), the auxiliary motor 40 is controlled according to an operating cycle comprising an initial phase during which the coupling element 52.1 is displaced from the insertion position to the coupling position, a connection phase during which the coupling element 52.1 cooperates with the coupling button 9.8 and reaches the coupling position so as to achieve a sealed connection of the first and second connection parts 3.2, 4.2, and a final phase during which the coupling element 52.1 is displaced from the coupling position to the insertion position. The auxiliary motor 40 can for example be driven in a first direction of rotation and according to an angle of rotation of approximately 180°, then be driven in a second direction of rotation, opposite to the first direction of rotation, and according to a rotation angle of approximately 180°.

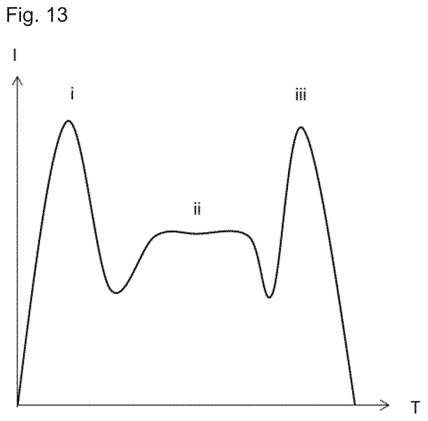

During the initial phase of the operating cycle of the auxiliary motor 40, a high torque must be supplied by the auxiliary motor 40 in order to initiate its rotation, which induces an initial current consumption peak i by the auxiliary motor 40 during the initial phase of the operating cycle of the auxiliary motor 40, as can be seen in FIG. 13. Furthermore, during the final phase of the operating cycle of the auxiliary motor 40, the auxiliary motor 40 is blocked in rotation, for example due to the presence of an end stop cooperating with the coupling element 52, which induces a final current consumption peak iii by the auxiliary motor 40 during the final phase of the operating cycle of the auxiliary motor 40, as can be seen in FIG. 13. In addition, during the connection phase of the operating cycle of the auxiliary motor 40, an important torque must be provided by the auxiliary motor 40 in order to allow the coupling element 52.1 to displace the coupling button 9.8 into a position ensuring the sealed connection of the first and second connecting parts 3.2, 4.2 of the first and second capsules 3, 4, which also induces a second consumed current peak ii by the auxiliary motor 40 during the connection phase of the operating cycle of the auxiliary motor 40, as can be seen in FIG. 13.

Nonetheless, in the absence of one or each of the first and second capsules 3, 4 in the receiving device 5, the force exerted by the coupling element 52.1 on the coupling button 9.8 is relatively weak and therefore does not induce a second consumed current peak ii during the connection phase of the operating cycle of the auxiliary motor 40. Similarly, in the event of a bad connection between the first and second connection parts 3.2, 4.2 of the first and second capsules 3, 4 (for example if the latter are not aligned), there will be no mechanical resistance, and there too, the force exerted by the coupling element 52.1 on the coupling button 9.8 will be relatively low and will therefore not induce a second consumed current peak ii during the connection phase of the operating cycle of the auxiliary motor 40. Furthermore, in the absence of the receiving device 5, the force exerted by the coupling element 52.1 is non-existent (since the coupling button 9.8 is absent) and therefore does not induce no second consumed current peak ii during the connection phase of the operating cycle of the auxiliary motor 40.

Thus, the presence of the second consumed current peak ii is representative not only of the presence of the first and second capsules 3, 4 in the receiving device 5, but also of the sealed connection of the first and second connection parts 3.2, 4.2 of the first and second capsules 3, 4 in the receiving device 5.

In an embodiment, which could moreover be the subject of an invention as such, the control unit 45 is advantageously configured to measure the current consumed by the auxiliary motor 40 associated with the coupling mechanism 52 during an operating cycle of the auxiliary motor 40, and to detect the establishment of a sealed connection between the first and second connection parts 3.2, 4.2 of the first and second capsules 3, 4 as a function of the current consumed by the auxiliary motor 40. The measurement made by the control unit 45 can for example be represented by the curve of intensity I of the auxiliary motor 40 as a function of time T in FIG. 13.

The control unit 45 is more particularly configured for:
detecting an initial current consumption peak i during the initial phase of the operating cycle of the auxiliary motor 40,
detecting a final consumed current peak iii during the final phase of the operating cycle of the auxiliary motor, and
detecting the establishment of a sealed connection between the first and second connection parts 3.2, 4.2 of the first and second capsules 3, 4 when a second consumed current peak ii, representative of a sealed connection between the first and second capsules 3, 4, is detected by the control unit 45 during the connection phase of the operating cycle of the auxiliary motor 40, and therefore between the detection of the initial consumed current peak i and the detection of the final consumed current peak iii. These provisions make it possible to preserve the integrity of the manufacturing apparatus 2. Indeed, it is thus possible to check, before starting the mixing cycle, the good connection, that is to say the sealed connection between the first and second capsules 3, 4. In other words, this makes it possible to detect a bad connection and therefore a risk of leakage between the first and second capsules 3, 4. This detection is then possible without resorting to one or more additional sensors, especially to expensive sensors (optical, infrared, mechanical, etc.).

Advantageously, the control unit 45 can be configured to emit a warning signal, for example audible or visual, in particular via the screen 60 and/or the loudspeaker previously mentioned, when no second current consumption peak ii, representative of a sealed connection between the first and second capsules 3, 4, is detected by the control unit 45 between the detection of the initial current consumption peak i and the detection of the final consumed current iii. These provisions make it possible to inform the user of the absence of one or each of the first and second capsules 3, 4 in the receiving device and/or of the poor connection of the latter.

In an embodiment, the control unit 45 is configured to activate the driving motor 39, and therefore to control displacements of the first actuation member 37 and of the second actuation member 38, only if the detection device has detected the presence of the receiving device 5 in the receiving housing 32 and/or only if the control unit 45 has detected a second consumed current peak ii representative of a sealed connection between the first and second capsules 3, 4.

In an embodiment, the control unit 45 is configured to stop the auxiliary motor 40 associated with the coupling mechanism 52 when a final consumed current peak iii is detected during the final phase of the operating cycle of the auxiliary motor 40.

These provisions make it possible to trigger the stopping of the auxiliary motor 40 while avoiding having to provide, in the mixing machine 6, a mechanical, optical or capacitive position detector, and therefore to optimize the manufacturing cost and the compactness of the manufacturing apparatus 2.

In an embodiment, the control unit 45 is configured to detect an operating anomaly of the manufacturing apparatus 2 when the initial consumed current peak is lower than a first predetermined threshold value and/or when the final consumed current is less than a second predetermined threshold value. Advantageously, the control unit 45 is configured to command a passage of the manufacturing apparatus 2 in error mode when an anomaly is detected by the control unit 45, in order to preserve the integrity of the manufacturing apparatus 2 and the safety of the user.

In an embodiment, the control unit 45 is configured to detect an operating anomaly of the manufacturing apparatus 2 when no initial consumed current peak i and/or when no final consumed current peak iii is detected by the control unit 45.

According to a variant of the invention, the presence of the first and second capsules 3, 4 in the receiving device 5 could be detected using an infrared detection device arranged in the mixing machine 6, and including for example an infrared source configured to emit an infrared beam in the direction of the first and second capsules 3, 4 and an infrared detector configured to detect the infrared beam emitted by the infrared source in the absence of the first and second capsules 3, 4.

According to another variant of the invention, the presence of the first and second capsules 3, 4 in the receiving device 5 could be detected by a first and a second mechanical contact devices configured to mechanically cooperate respectively with the first and second capsules 3, 4 when the receiving device 5 equipped with the first and second capsules 3, 4 is received in the receiving housing 32. Each of the first and second mechanical contact devices could for example include an electro-mechanical contact or a capacitive contact.

Method of Use

At least one method for manufacturing a composition, such as a cosmetic product, using the manufacturing apparatus 2 will now be described. This manufacturing method is composed of several sub-methods (called qmethods» for reasons of clarity), whose one or more variants will be described. A distinction is made in particular between a preliminary method Ep, an initialization method Ei, a mixing method Em, then a removal method Er.

In particular, these methods (or their variants) are advantageously implemented using the different embodiments of the manufacturing apparatus 2 described above. Preferably, most of the steps of the methods Ei, Em and Er are stored in the memory 45.2, of the non-volatile type, in the form of instructions in lines of code able to be executed by the processor 45.1.

A preliminary method Ep comprises a preliminary step Ep1 to any use of the manufacturing apparatus 2 which consists either in connecting it to the mains or in recharging the battery 44. In addition, this preliminary step Ep1 can be preceded or followed by a step Ep2 for positioning the manufacturing apparatus 2 on a flat support, possibly with a power-up step.

Then, an initialization method Ei is implemented. In a step Ei1 («receiving step), the processor of the manufacturing machine 2 receives a starting instruction. This starting setpoint is typically generated by an action by a user (contact with the touch screen 60, press button, switch, etc.).

Following this step Ei1, in a step Ei2 («verification step), the method ensures that the actuation system 35 is in neutral position, allowing the insertion of the receiving device 5 or the insertion of the capsules 3, 4. Typically, it must be ensured that the receiving housing 32 (for the insertion of the receiving device 5) is not obstructed by the actuation system 35. During this step Ei2, it is also necessary to check that the clamping mechanism 54, the coupling mechanism 52, and the retention mechanism 50 are deactivated, that is to say in their respective insertion position.

Following this step Ei2, the receiving device containing the capsules 3, 4 can be manually inserted into the receiving housing 32.

In a following step Ei3 (qclosing step), at least one among: the clamping mechanism 54, the coupling mechanism 52, the retention mechanism 50 are activated, that is to say they are displaced. This step Ei3 consists for example of an instruction by the processor intended for the auxiliary motor 40 to trigger it, so that it drives the three aforementioned mechanisms in the case where they are all connected to the common pinion (or pulley) 40.1. The auxiliary motor 40 moves from a first position to a second position, so that the clamping mechanism 52, the coupling mechanism 54 and the retention mechanism 50 move from their respective insertion position to their respective clamping, coupling and retention positions. Preferably, the auxiliary motor 40 maintains the second position at the end of the step Ei3, even though it is no longer powered.

The steps Ei1, Ei2 and Ei3 are executed in particular by the processor 45.1.

In a step Ei4 («step of detecting the presence of shuttleD), the control unit 45 detects the presence of the receiving device 5 in the receiving housing of the mixing machine 6 by detecting electrical continuity between the tracks of electrical contact 46.51, 46.52 provided on the receiving device 5 and the electrical contact tracks 31.51, 31.52 provided on the mixing machine 6.

In a step Ei5 («step of detecting a connectionD), the control unit detects the establishment of a sealed connection between the first and second connection parts 3.2, 4.2 of the first and second capsules 3, 4 from a detection of a second consumed current peak ii by the auxiliary motor 40 associated with the coupling mechanism 52 during a connection phase of an operating cycle of the auxiliary motor.

These steps advantageously take place in the order indicated above, but it will be understood that they can also take place in a different order, without departing from the scope of the invention. In particular, step Ei4 can take place before step Ei3.

At the end of this initialization method Ei, the mixing machine 6 is ready to begin work on the first and second capsules 3, 4: this is the subject of the mixing Em and removal Er methods. Nonetheless, as explained previously, depending on the result of steps Ei4 and/or Ei5 (negative result, no detection of the presence of a shuttle or connection), the mixing method Em may not be launched, in order to preserve the security of the user and/or of the mixing machine 6. In this case, a step Ei6 («alert step>) can be launched in order to inform the user of an absence of the receiving device 5 (step Ei4 and/or Ei5), or an absence of, or a bad connection between, the first and/or second capsules 3, 4 (step Ei5). This allows the user to remedy the problem quickly and easily, for example by correctly repositioning the first and/or second capsules 3, 4.

The mixing method Em comprises a first step Eml of the preparation phase (qprimary step of setting the actuation system in motionD), during which the connecting weld of the capsule positioned furthest from the heating element 46 (the second capsule 4 in the figures), and this capsule is compressed so that its contents are partly sent to the capsule closest to the heating element 46. According to the presented embodiment, the second actuation member 38 is set in motion to break the bonding weld in the second capsule 4 (which comprises for example the fatty phase formulation). In this way, part of the content of the second capsule 4 is sent to the side of the first capsule 3, in particular in the connecting passage 3.3 (because the connecting weld of the first capsule 3 is not yet broken). The second actuation member 38 is preferably set in motion according to its actuation stroke C38. For reasons of design simplification, there is not necessarily a partial stroke sensor for the second actuation device 38.

In a step Em2 of the preparation phase («secondary step of setting the actuation system in motionD or qprestressing step), the first actuation member 37 is set in motion according to a partial stroke strictly less than its actuation stroke C37 and keeps its position, in order to exert a prestress on the first capsule 3 (which comprises for example the aqueous phase formulation) so that the flat face 3.7 is pressed against the diffusion plate 46.2. This prestress makes it possible to promote the heat exchange between the diffusion plate 46.2 and the first capsule 3 during a subsequent step Em3 (qheating step). It should be noted that this pressurization of the first capsule 3 against the diffusion plate 46.2, thanks to the movement of the first actuation member 37 on a partial stroke, is carried out without causing the rupture of the connecting weld in the first capsule 3 (which would cause the formulation of the first capsule 3 to be sent to the second capsule 4).

In the step Em3 of the preparation phase (qheating step), the heating element 46 is activated to generate heat intended for the first capsule 3. As the heating element 46 is positioned on the flat face side 3.7 of the first capsule 3, and that the prestressing step has allowed good thermal contact between the diffusion plate 46.2 and the first capsule 3, the heat supplied by the heating element 46 is well distributed over the contents of the first capsule 3. The step Em3 is therefore activated in the absence of any movement of the actuation members 37, 38.

During the step Em3 of the preparation phase, the temperature of the heating element 46 reaches a target temperature Tc comprised between 80° C. and 90° C. The object of this target temperature Tc is that the content of the first capsule 3 reaches a target temperature Tc′ also comprised between 80° C. and 90° C. and preferably in the range of 85° C. Indeed, it was found that the temperature of the content of the first capsule 3 during this heating step Em3 substantially corresponded to the target temperature Tc of the heating element 46, with however a slight time lag.

Then, in a step Em3′ of the kneading phase (qmixing step), the heating element 46 is deactivated then the first actuation member 37 is set in motion according to its nominal stroke to break the bonding weld in the first capsule 3. Cutting off the electrical power supply to the heating element 46 prior to the activation of the first actuation member 37 makes it possible to have all of the power supplied by the electrical power source available to supply the driving motor 39. Such a characteristic is particularly advantageous in the case where the mixing machine 6 is supplied by a supply transformer or a battery 44 of low power. Indeed, it makes it possible to prevent the power supplied to the driving motor 39 from being insufficient to allow the breaking of the connecting weld of the first capsule 3 (which would then lead to a blocking of the device), this step of breaking the connecting weld requiring a high motor torque. When the first actuation member 37 reaches its actuation stroke end C37, the contents of the first capsule 3 are sent to the second capsule 4 and the two formulations can then circulate freely from one capsule 3.4 to the other 4.3 passing through the connection parts 3.2, 4.2 with each back-and-forth movement of the actuation system 35, the connecting welds present originally in each of the capsules 3, 4 having been broken.

Subsequently, the steps Em4, EmS, Em6 are successive kneading steps, with or without heating (it is the kneading phase).

The kneading phase step Em4 («kneading step without heatingD) consists in setting the actuation members 37, 38 in motion back and forth without activating the heating element 46, that is to say without heating. During this step, the first and second capsules 3, 4 are deformed at least once each. According to an embodiment, the step Em4 lasts at least 1.4 s and preferably between 2s and 4s. Such a kneading step without heating makes it possible to launch the driving motor 39 at a constant speed while benefiting from all the power of the electrical power source.

The steps Em1, Em2 and Em3, Em3′, Em4 alternate setting in motion of the actuation system 35 and heating with the heating element 46. This translates concretely into a power supply dedicated either to the actuation system 35 or to the heating element 46. This exclusive alternation makes it possible to preserve the battery 44 by distributing the moments of strong power. Indeed, the engagement of the setting in motion generates a high resistive torque which imposes a high motor torque and the rise in temperature also requires a high power: the battery 44 is then highly stressed. This alternating solution also makes it possible to reduce the size of components, which is a design constraint when creating a portable and on battery mixing machine.

On the other hand, once the temperature is close to the target temperature Tc′ and once the actuation system 35 is already in motion, the stresses on the battery 44 are reduced and allow a power supply to the heating element 46 and to the actuation system 35 in parallel: this is the object of step Em5.

During step Em5 of the kneading phase («mixing step with heating»), the actuation system 35 remains activated and the heating element 46 is reactivated in order to maintain the mixture of the formulations at a temperature, which is preferably the target temperature Tc′. Therefore, the heating element is maintained at the target temperature Tc. This step Em5 lasts for example between 5s and 30s, preferably between 7s and 15s. Although the battery 44 is less stressed than for an engagement or a rise in temperature, it may tend to discharge quickly in this phase which is therefore limited in duration.

Nevertheless, this step Em5 is long enough for the first and second capsules 3, 4 to be deformed several times each and for the emulsion obtained by mixing the formulations to be satisfactory.

Between step Em4 and Em5, the actuation system 35 has not been interrupted.

Subsequently, the kneading phase step Em6 («cooling step with kneading») is implemented. Alternatively, this step is done without kneading but it is preferable to keep the actuation system activated to improve or maintain the homogenization of the formulations. During step Em6, the temperature of the cream decreases to a removal temperature Tr comprised between 35° C. and 48° C., preferably 38° C. and 42° C. In the case of the presented embodiment, the removal temperature Tr′ of the cream corresponds to a removal temperature Tr of the heating element 46 comprised between 55° C. and 60° C. This temperature difference between the contents of the capsules 3,4 and the temperature of the heating element 46 during the cooling step is explained in particular by the fact that, during kneading, the composition is only present part of the time in the first capsule 3 and therefore opposite the diffusion plate 46.2 at which the temperature measurement is made.

The simplest technique for cooling is to turn off the power to the heating element 46 and allow the cream to cool with air at ambient temperature. Consequently, the duration of step Em6 effectively depends on the ambient temperature. In this respect, a temperature sensor is advantageously positioned in the mixing machine 6, and more precisely in the receiving device 5. In order to limit the number of temperature sensors, it is the same sensor which measures the temperature of the heating element 46.

As in the illustrated embodiment, the temperature sensor measures the temperature of the heating element 46, the same sensor is reused: this means that the end of the step Em6 is determined by the temperature measured by said sensor, that is to say the removal temperature Tr comprised between 55° C. and 60° C.

Once the removal temperature has been reached, the actuation system 35 is stopped.

The cooling step Em6 generally lasts at least 20 s and preferably 40 s.

In a variant, the step Em6 could also advantageously comprise a minimum kneading time, for example in the range of 40 s, making it possible to guarantee a good emulsion, then an additional mixing time which only occurs when the removal temperature Tr′ has not yet been reached. In other words, kneading is still performed for a certain time even if the temperature is lower than the removal temperature Tr′.

It should be noted that the mixing machine 6 could according to a non-illustrated embodiment comprise a cooling system to actively cool the cream and speed up the processor. For example, a cooling system could be provided with a small fan in addition or not to a cooling element, the fan forcing air circulation in the mixing machine 6, and therefore a cooling by forced convection.

Once the mixing method Em is complete, the removal method Er can be initiated. This removal method Er will now be described.

As the previous steps take some time (more than a minute in general), it is probable that the user does not stay next to the mixing machine 6 but that he goes about his usual activities (breakfast, radio, television, buttering toast, dressing, ironing, etc.). Thus, it is important that the mixing machine 6 can hold the cream in a ready-to-use state for a fixed period of time.

To this end, in a step Er1 («transfer step for storage»), the actuation system 35 is activated once to transfer the cream into the capsule which is on the side of the heating element 46 (that is to say the first capsule 3 here). This step is optional if step Em6 has already stopped in the correct configuration.

In a step Er2 («pre-stressing keeping step), the actuation system 35 is returned to the pre-stressed position, where the first actuation member 37 exerts a pre-stress on the first capsule 3 to press it against the diffusion plate 46.2, then, in a step Er3 («temperature keeping step»), the heating element 46 is reactivated to hold the cream at the removal temperature Tr′. The pre-stressing keeping step Er2 allows better heat conduction, like the step Em2. Preferably, a kneading or movement of the actuation system 35 is implemented periodically during step Er3 to guarantee a good emulsion, the latter possibly being partly damaged by the presence of hot spots on the diffusion plate 46.2.

In a variant, the removal method may include, instead of step Er2, a step Er2′ («step of keeping in neutral positionD) in which the actuation system 35 is activated to be placed in a neutral position, that is to say without stressing the capsules, and in particular without forcing the first capsule 3 against the heating element 46. Surprisingly, such a variant makes it possible to maintain a better emulsion and to avoid having to resort to periodic kneading during the keeping warm phase.

The step Er3 is implemented for a predetermined waiting period. This duration is less than 15 min, so as not to power the heating element 46 too long, but greater than 1 min, to allow flexibility in the management of the time in the morning for the user, and preferably in the range of 5 min.

In other words, this means that the user has between 1 min and 15 min, and preferably in the range of 5 min (depending on factory settings or user settings) after the end of the movement of the actuation system 35 to retrieve the cream at the correct temperature.

As soon as the user is ready to use the cream, he touches the touch screen or presses a button, which triggers a step Er4 («step of receiving removal instructions»), during which the mixing machine 6 receives a removal instruction.

Then, in a step Er5 («neutral position step»), the actuation system 35 is activated to be placed in the neutral position.

In the case where the actuation system 35 was previously pre-stressed at the level of the first actuation member 37, the latter must complete its movement, which displaces the formulation into the second capsule 4, then the actuation system 35 stops in the neutral position which corresponds to a position suitable for the extraction of the receiving device 5. This position also corresponds to a starting position suitable for carrying out a next manufacturing cycle implementing the method described above. Indeed, the second actuation member 38 is then ready to come and compress the second capsule 4 during step Em1 as soon as the driving motor 39 is started.

In the case of the variant where the actuation system 35 has been placed in neutral position during step Er2′ for the temperature keeping of step Er3, it may be necessary for the actuation system 35 to go back and forth to be positioned in the neutral position suitable for the performance of a next manufacturing cycle implementing the method described above, that is to say with the second actuation member 38 ready to come and compress the second capsule 4 during step Em1.

During this back and forth of the actuation system 35 the cream present in the first capsule is partially sent into the second capsule.

Finally in a last step Er6 («unlocking step»), each mechanism activated in step Ei3 is placed in the insertion position. Similarly, this step Er6 involves an activation of the auxiliary motor 40.

Subsequently, the user grabs the receiving device 5 and removes it from its receiving housing 32. Then he presses on the actuation faces 8.1, 9.1 to rotate the paddles in order to drive out the cream present in the first and second capsule 3, 4 through the outlet passage 3.5 of the first capsule 3. Finally, it suffices to remove the capsules from the receiving device 5 so that the latter is once again ready for use.

Indeed, no part of the mixing machine 6 (manufacturing apparatus or receiving device) has been in contact with the formulations.

The different implementation steps of the method described above, which can for example be implemented successively, are therefore the following:

Ei1: step of receiving a starting instruction (implemented by the mixing machine and more specifically by the processor),

Ei2: step of positioning the actuation system (implemented by the mixing machine and more precisely by the processor which controls the driving motor),

Ei3: step of closing, preferably in parallel, the clamping, retention and coupling mechanisms (implemented by the mixing machine and more precisely by the processor which controls the auxiliary motor),

Ei4: step of detecting the presence of the receiving device 5 in the receiving housing 32 (implemented by the mixing machine 6 and more precisely by the processor),

Ei5: step of detecting the sealed connection of the first and second capsules 3, 4 (implemented by the mixing machine 6 and more precisely by the processor)

Em1: primary step of setting in motion the actuation system to break the bonding weld of one of the capsules (implemented by the mixing machine and more precisely by the processor which controls the driving motor),

Em2: secondary step of setting the actuation system in motion to exert a prestress on the other capsule (implemented by the mixing machine and more precisely by the processor which controls the driving motor),

Em3: step of heating the prestressed capsule, (implemented by the mixing machine and more precisely by the processor which controls the heating element),

Em3′: step of mixing by setting the actuation system in motion to break the bonding weld of the other capsule and allow free circulation of the formulations from one capsule to another (implemented by the mixing machine and more precisely by the processor which drives the driving motor),

Em4: mixing step without heating to start the motor at constant speed (implemented by the mixing machine and more precisely by the processor which controls the driving motor),

Em5: mixing step with heating to produce the emulsion (implemented by the mixing machine and more precisely by the processor which controls the driving motor and the heating element),

Em6: cooling step with mixing and without heating (cooling) down to the removal temperature (implemented by the mixing machine including the processor which controls the driving motor),

Er1 : optional transfer step of storing with movement the actuation system (implemented by the mixing machine and more precisely by the processor which controls the driving motor),

Er2: step of setting the pre-stressed position of the actuation system (implemented by the mixing machine and more precisely by the processor),

Er2′: step of (alternative to step Er2) placing the actuation system in neutral position (implemented by the mixing machine and more precisely by the processor which controls the driving motor)

Er3: temperature keeping step (implemented by the mixing machine and more precisely by the processor),

Er4: step of receiving a removal instruction (implemented by the mixing machine and more precisely by the processor),

Er5: step of placing the actuation system in neutral position (implemented by the mixing machine and more precisely by the processor which controls the driving motor)

Er6: unlocking step (implemented by the mixing machine and more precisely by the processor which controls the auxiliary motor).

1. A manufacturing apparatus for manufacturing a composition, comprising:
a first capsule containing a first formulation and comprising a first connection part, and a second capsule containing a second formulation and comprising a second connection part configured to be connected to the first connection part,
a receiving device configured to receive the first capsule and the second capsule,
a mixing machine including:
a receiving housing configured to at least partially receive the receiving device equipped with the first and second capsules,
a control unit configured to control the operation of the manufacturing apparatus, wherein the manufacturing apparatus further includes a detection device configured to detect the presence of the receiving device in the receiving housing, and in that the control unit is configured to control the operation of the manufacturing apparatus at least in part based on the detection, by the detection device, of the presence of the receiving device in the receiving housing.

2. The manufacturing apparatus according to claim 1, wherein the mixing machine includes an actuation system comprising:
a first actuation member positioned on one side of the receiving housing, and movable inside the receiving housing, in order to transmit a pressure force to the first capsule when the receiving device equipped with the first and second capsules, is received in the receiving housing of the mixing machine, and
a second actuation member, positioned on another side, preferably opposite, of the receiving housing, and movable inside the receiving housing, in order to transmit a pressure force to the second capsule when the receiving device equipped with the first and second capsules is received in the receiving housing of the mixing machine.

3. The manufacturing apparatus according to claim 2, wherein the control unit is configured to activate the actuation system only if the detection device has detected the presence of the receiving device in the receiving housing.

4. The manufacturing apparatus according to claim 1, wherein the receiving device includes a first electrical circuit portion and the mixing machine includes a second electrical circuit portion configured to electrically cooperate with the first electrical circuit portion when the receiving device equipped with the first and second capsules is received in the receiving housing of the mixing machine, the detection device being configured to detect the electrical cooperation between the first and second electrical circuit portions so as to detect the presence of the receiving device in the receiving housing of the mixing machine.

5. The manufacturing apparatus according to claim 4, wherein the detection device is configured to detect an electrical continuity between the first and second electrical circuit portions when the receiving device equipped with the first and second capsules is received in the receiving housing of the mixing machine.

6. The manufacturing apparatus according to claim 4, wherein the first electrical circuit portion comprises a first and a second electrical contact tracks provided on the receiving device and the second electrical circuit portion comprises a first and a second electrical contact tracks provided on the mixing machine and configured to be respectively engaged with the first and second electrical contact tracks provided on the receiving device when the receiving device equipped with the first and second capsules is received in the receiving housing of the mixing machine, the detection device being configured to detect an electrical continuity between the first and second electrical contact tracks provided on the receiving device and the first and second electrical contact tracks provided on the mixing machine.

7. The manufacturing apparatus according to any one of claim 4, wherein the receiving device includes a heating circuit configured to heat at least one of the first and second capsules when the receiving device equipped with the first and second capsules is received in the receiving housing of the mixing machine, the heating circuit including the first electrical circuit portion.

8. The manufacturing apparatus according to claim 7, wherein the heating circuit includes a heating element configured to heat at least one of the first and second capsules when the receiving device equipped with the first and second capsules is received in the receiving housing of the mixing machine.

9. The manufacturing apparatus according to claim 8, wherein the heating circuit includes a temperature sensor configured to measure a temperature prevailing near the heating element.

10. The manufacturing apparatus according to claim 9, wherein the heating circuit includes a temperature regulating circuit which includes the temperature sensor and the first electrical circuit portion.

11. The manufacturing apparatus according to claim 1, wherein the mixing machine includes a detection element configured to detect the presence of the first and second capsules in the receiving device when the receiving device is received in the receiving housing, the detection element being preferably formed by the control unit.

12. The manufacturing apparatus according to claim 1, wherein the mixing machine includes a coupling mechanism configured to establish a sealed connection between the first and second connection parts of the first and second capsules when the receiving device equipped with the first and second capsules is received in the receiving housing.

13. The manufacturing apparatus according to claim 12, wherein the coupling mechanism includes a coupling element which is movable between an insertion position and a coupling position, and an auxiliary motor which is configured to displace the coupling element between the insertion position and the coupling position, the coupling element being configured to:
in the insertion position, do not interfere with the insertion and removal of the receiving device in the receiving housing and,
in the coupling position, exert a force on an actuation face of the receiving device so as to establish a sealed connection between the first and second connection parts of the first and second capsules when the receiving device equipped with the first and second capsules is received in the receiving housing.

14. The manufacturing apparatus according to claim 13, wherein the control unit is configured to measure the current consumed by the auxiliary motor during an operating cycle of the auxiliary motor, and to detect the presence of the first and second capsules in the receiving device and the establishment of a sealed connection between the first and second connection parts of the first and second capsules when a consumed current peak, representative of a sealed connection between the first and second capsules, is detected by the control unit during the operating cycle of the auxiliary motor.

15. The manufacturing apparatus according to claim 14, wherein the control unit is configured to detect an initial consumed current peak during an initial phase of an operating cycle of the auxiliary motor and to detect a final consumed current peak during a final phase of an operating cycle of the auxiliary motor, the control unit being configured to detect the establishment of a sealed connection between the first and second connection parts of the first and second capsules when a consumed current peak, representative of a sealed connection between the first and second capsules, is detected by the control unit between the detection of the initial consumed current peak and-the detection of the final consumed current peak.

16. The manufacturing apparatus according to claim 11, wherein the control unit is configured to emit a warning signal when the presence of the first and second capsules in the receiving device is not detected by the detection element.

17. The manufacturing apparatus according to claim 16, wherein the control unit is configured to emit a warning signal when the presence of the receiving device in the receiving housing is not detected by the detection device.

18. The manufacturing apparatus according to claim 1, wherein the receiving device includes a first electrical circuit portion and the mixing machine includes a second electrical circuit portion configured to electrically cooperate with the first electrical circuit portion when the receiving device equipped with the first and second capsules is received in the receiving housing of the mixing machine, the detection device being configured to detect electrical cooperation between the first and second electrical circuit portions so as to detect the presence of the receiving device in the receiving housing of the mixing machine.

19. The manufacturing apparatus according to claim 18, wherein the detection device is configured to detect an electrical continuity between the first and second electrical circuit portions when the receiving device equipped with the first and second capsules is received in the receiving housing of the mixing machine.

20. The manufacturing apparatus according to claim 19, wherein the first electrical circuit portion comprises a first and a second electrical contact tracks provided on the receiving device and the second electrical circuit portion comprises a first and a second electrical contact tracks provided on the mixing machine and configured to be respectively engaged with the first and second electrical contact tracks provided on the receiving device when the receiving device equipped with the first and second capsules is received in the receiving housing of the mixing machine, the detection device being configured to detect an electrical continuity between the first and second electrical contact tracks provided on the receiving device and the first and second electrical contact tracks provided on the mixing machine.
